(19) United States
(12) Patent Application Publication
(10) Pub. No.: US 2025/0022641 A1
(43) Pub. Date: Jan. 16, 2025

(54) ELECTRONIC COMPONENT AND METHOD FOR MANUFACTURING THE SAME

(71) Applicant: Alps Alpine Co., Ltd., Tokyo (JP)

(72) Inventors: Ikuo KOYAMA, Niigata-ken (JP); Akira MIYATAKE, Niigata-ken (JP); Mitsuo KAWASAKI, Niigata-ken (JP); Tomoya KUWABARA, Niigata-ken (JP)

(21) Appl. No.: 18/742,502

(22) Filed: Jun. 13, 2024

(30) Foreign Application Priority Data
Jul. 13, 2023 (JP) 2023-115076

(51) Int. Cl. H01F 5/04; H01F 27/02; H01F 27/28; H01F 27/29; H01F 27/32; H01F 41/10

(52) U.S. Cl. CPC H01F 5/04; H01F 27/022; H01F 27/2828; H01F 27/292; H01F 27/323; H01F 41/10

(57) ABSTRACT

An electronic component according to an aspect of the present invention includes a substrate and a coil part having an annular shape in plan view as viewed in a thickness direction of the substrate. The coil part includes: a first wiring layer having a coil pattern and formed on a first substrate face of two end faces of the substrate in a thickness direction; a second wiring layer having a coil pattern and formed on a second substrate face of the two end faces of the substrate, the second substrate being different from the first substrate face; and a conducting part covering surfaces of the first wiring layer and the second wiring layer and electrically connecting the first wiring layer and the second wiring layer through a via hole extending through the substrate.

### CLAIM OF PRIORITY

This application claims benefit of Japanese Patent Application No. 2023-115076 filed on Jul. 13, 2023, which is hereby incorporated by reference.

### BACKGROUND OF THE INVENTION

### 1. Field of the Invention

The present invention relates to an electronic component and a method for manufacturing the same.

### 2. Description of the Related Art

In the field of electronic components such as inductors, with the progress of reduction in size and high functionality of electronic devices, compact and low-resistance electronic components to be mounted on the electronic devices have been developed. For example, Japanese Unexamined Patent Application Publication No. 2021-103796 discloses an electronic component (power inductor) in which a coil is embedded in a body containing a metal powder and an insulating resin.

In the electronic component described therein, the coil is formed by forming, on both upper and lower surfaces of a substrate, a first metal plating film having a spiral coil pattern and a second metal plating film covering the upper surface and the side surface of the first metal plating film. The coil is disposed in the body including a metal powder and an insulating resin. The ends of the spiral coil are exposed at two opposing side surfaces of the body, and the two side surfaces are provided with external electrodes so as to be in contact with the ends.

In the electronic component described therein, the first metal plating film on the upper surface of the substrate and the first metal plating film on the lower surface of the substrate are electrically connected to each other through a via hole provided in the substrate to electrically connect coil pattern wires on the upper and lower surfaces of the substrate. In this connection structure, it is preferable that the first metal plating film be embedded over the entire circumference of the opening edge of the via hole. However, if the first metal plating film is formed in that manner, the opening area of the via hole is limited by the width of the first metal plating film, making it difficult to reduce the electric resistance (connection resistance) between the coil pattern wires through the via hole.

### SUMMARY OF THE INVENTION

The present invention provides an electronic component in which the electric resistance of a coil is reduced, and a method for manufacturing the same.

An electronic component according to the present invention includes: a substrate having a first substrate face and a second substrate different from the first substrate face, the substrate faces being two end faces of the substrate in a thickness direction of the substrate; and a coil part having an annular shape in plan view as viewed in the thickness direction of the substrate. The coil part includes: a first wiring layer having a coil pattern and formed on the first substrate face; a second wiring layer having a coil pattern and formed on the second substrate face; and a conducting part covering surfaces of the first wiring layer and the second wiring layer and electrically connecting the first wiring layer and the second wiring layer through a via hole extending through the substrate.

In the electronic component according to the present invention, the coil part may include: a first via pad portion having a maximum width that is smaller than or equal to a wiring width of the first wiring layer, constituting one end of the first wiring layer in a wiring direction, and surrounding an opening of the via hole on the first substrate face side; and a second via pad portion having a maximum width that is smaller than or equal to a wiring width of the second wiring layer, constituting one end of the second wiring layer in the wiring direction, and surrounding an opening of the via hole on the second substrate face side.

In the electronic component according to the present invention, the coil pattern of the first wiring layer and the coil pattern of the second wiring layer may have a spiral shape in plan view as viewed in the thickness direction of the substrate, and the conducting part may be in contact with one end of the spiral first wiring layer and one end of the spiral second wiring layer through the via hole.

The electronic component according to the present invention may further include an insulating layer covering surfaces of the conducting part.

The electronic component according to the present invention may further include: a body containing a magnetic powder and enclosing the coil part; a first external electrode provided on an outer surface of the body and electrically connected to the first wiring layer; and a second external electrode provided on an outer surface of the body so as to form a pair with the first external electrode and electrically connected to the second wiring layer.

In the electronic component according to the present invention, the body may enclose the coil part such that a connection end of the first wiring layer connected to the first external electrode and a connection end of the second wiring layer connected to the second external electrode are exposed.

The electronic component according to the present invention may further include a lead-out wiring part extending from the second substrate face in the thickness direction of the substrate at a position away from the second wiring layer; an electrode conducting part that covers a surface of the lead-out wiring part and a surface of a connection end of the first wiring layer, the connection end overlapping the lead-out wiring part in plan view as viewed in the thickness direction of the substrate, and that electrically connects the lead-out wiring part and the connection end through an electrode via hole extending through the substrate; a first internal terminal electrically connecting the first wiring layer and the first external electrode through the electrode conducting part; and a second internal terminal electrically connecting the second wiring layer and the second external electrode through the conducting part that covers a surface of a connection end of the second wiring layer, the connection end forming a pair with the connection end of the first wiring layer.

The electronic component according to the present invention may further include: a first base layer formed on the first substrate face; and a second base layer formed on the second substrate face. The first base layer may be located between the first substrate face and the first wiring layer, and the second base layer is located between the second substrate face and the second wiring layer.

In the electronic component according to the present invention, the first base layer may have the same coil pattern as the first wiring layer, and the second base layer may have the same coil pattern as the second wiring layer.

In the electronic component according to the present invention, the first base layer and the second base layer may be conductor layers containing at least one of nickel, chromium, or titanium, and the first wiring layer, the second wiring layer, and the conducting part may be conductor layers containing copper.

In the electronic component according to the present invention, the conducting part may include: a first coating layer covering a surface of the first wiring layer; a second coating layer covering a surface of the second wiring layer; and a via conductor part filling the via hole.

A method for manufacturing an electronic component according to the present invention includes: a base layer forming step of forming a base layer on each of a first substrate face at one end and a second substrate face at the other end of a substrate in a thickness direction of the substrate; a pattern forming step of forming a coil pattern on each of the base layer on the first substrate face and the base layer on the second substrate face; a first plating step of plating a surface of the base layer having the coil pattern on the first substrate face to form a first wiring layer having a first cavity that extends to the first substrate face and plating a surface of the base layer having the coil pattern on the second substrate face to form a second wiring layer having a second cavity that extends to the second substrate face at a position overlapping the first cavity in the thickness direction of the substrate; a via hole forming step of forming a via hole extending through the substrate inside the first cavity and the second cavity; and a second plating step of plating surfaces of the first wiring layer and the second wiring layer to form a conductor layer and filling the via hole with a via conductor part grown from the conductor layer to electrically connect the first wiring layer and the second wiring layer.

In the method for manufacturing the electronic component according to the present invention, the via hole may be formed by laser processing or etching in the via hole forming step.

### BRIEF DESCRIPTION OF THE DRAWINGS

FIG. 1 is a perspective view showing a configuration example of an electronic component according to a first embodiment of the present invention;

FIG. 2 is a schematic sectional view showing a configuration example of the electronic component in FIG. 1, taken along line II-II;

FIG. 3 is a schematic sectional view showing a configuration example of the electronic component in FIG. 1, taken along line III-III;

FIG. 4 is a schematic sectional view showing a configuration example of the electronic component in FIG. 2, taken along line IV-IV;

FIG. 5 is a schematic sectional view showing a configuration example of the electronic component in FIG. 2, taken along line V-V;

FIG. 6 is a schematic sectional view showing a configuration example of the electronic component in FIG. 4, taken along line VI-VI;

FIG. 7 is a flow diagram showing an example method for producing a coil part according to the first embodiment;

FIG. 8 is a flow diagram showing an example method for manufacturing an electronic component including the coil part according to the first embodiment;

FIG. 9A schematically shows an example coil pattern formed on a first base layer of a first substrate face;

FIG. 9B schematically shows an example coil pattern formed on a second base layer of a second substrate face;

FIG. 10 is a schematic sectional view showing a configuration example of an electronic component according to a second embodiment of the present invention;

FIG. 11 is a schematic sectional view showing a configuration example of the electronic component in FIG. 10, taken along line XI-XI;

FIG. 12 is a flow diagram showing an example method for producing a coil part according to the second embodiment;

FIG. 13 is a flow diagram showing an example method for manufacturing an electronic component including the coil part according to the second embodiment; and

FIG. 14 is a schematic sectional view showing a configuration example of an electronic component according to a modification of the first embodiment.

### DESCRIPTION OF THE PREFERRED EMBODIMENTS

Preferred embodiments of an electronic component and a method for manufacturing the same according to the present invention will be described in detail below with reference to the accompanying drawings. The present invention is not limited by the embodiments. Note that the drawings are schematic, and the dimensional relationship between elements, the ratio of elements, and the like may be different from those in actuality. The drawings may include portions having different dimensional relationships and ratios. In the drawings, the same reference numerals denote the same components.

### First Embodiment

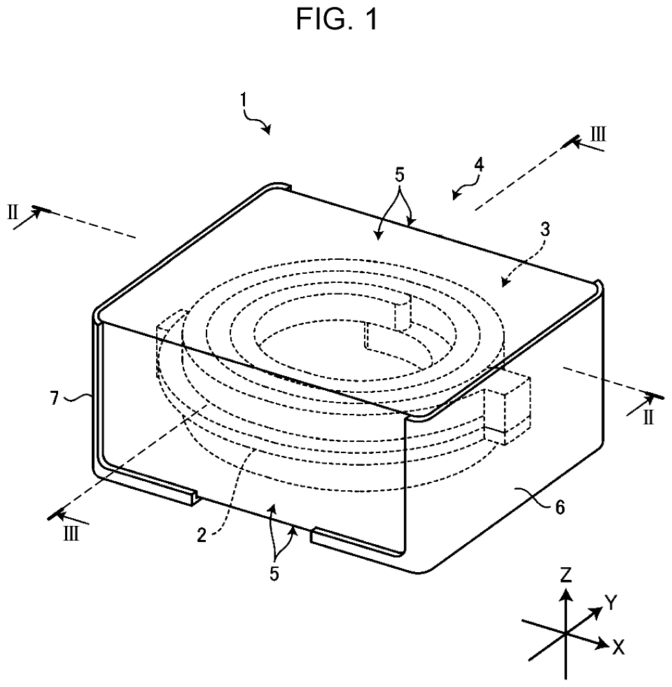

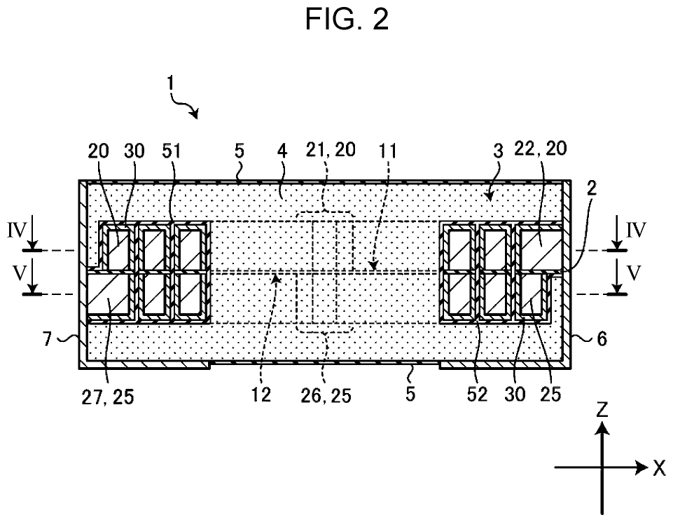

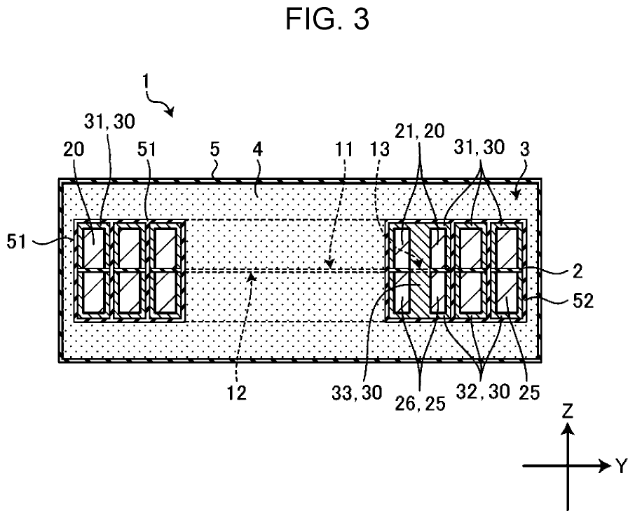

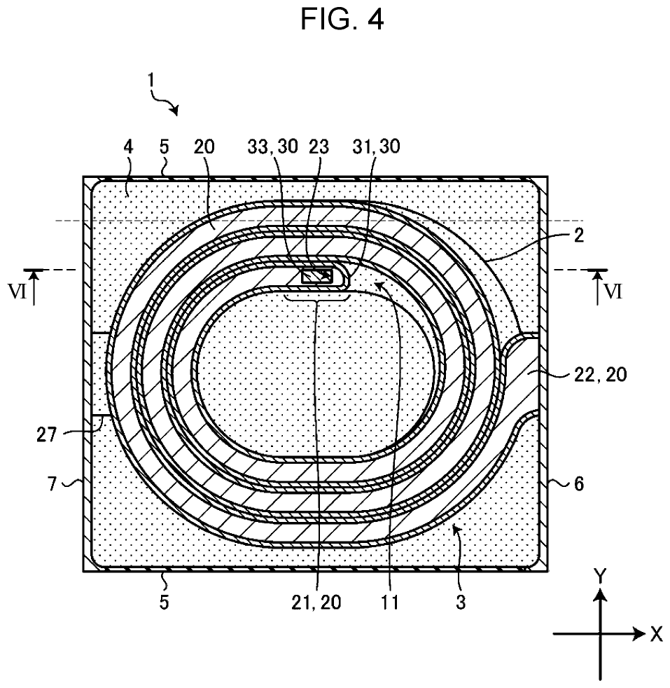

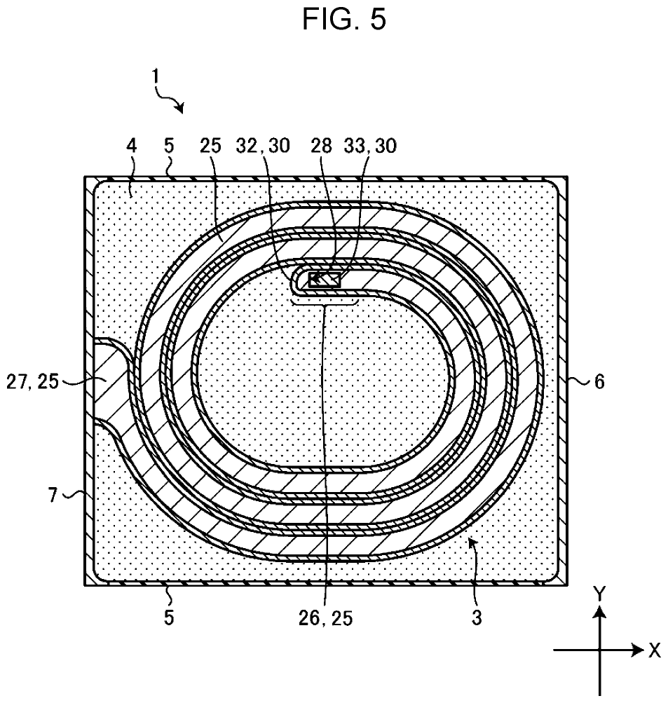

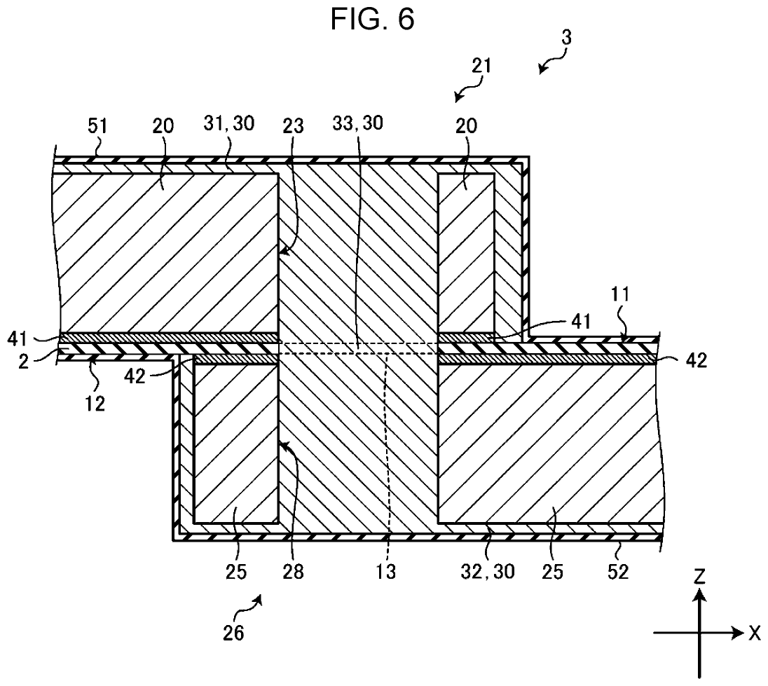

First, a configuration of an electronic component according to a first embodiment of the present invention will be described. FIG. 1 is a perspective view showing a configuration example of the electronic component according to the first embodiment. FIG. 2 is a schematic sectional view showing a configuration example of the electronic component in FIG. 1, taken along line II-II. FIG. 3 is a schematic sectional view showing a configuration example of the electronic component in FIG. 1, taken along line III-III. FIG. 4 is a schematic sectional view showing a configuration example of the electronic component in FIG. 2, taken along line IV-IV. FIG. 5 is a schematic sectional view showing a configuration example of the electronic component in FIG. 2, taken along line V-V FIG. 6 is a schematic sectional view showing a configuration example of the electronic component in FIG. 4, taken along line VI-VI. FIG. 6 is an enlarged partial sectional view showing a structure electrically connecting a first wiring layer 20 and a second wiring layer 25 constituting a coil part 3 of the electronic component 1 according to the first embodiment.

The electronic component 1 according to the first embodiment is, for example, an inductor, and includes: a substrate 2; the coil part 3 formed on the substrate 2; a body 4 enclosing the coil part 3; an exterior coating 5 covering the outer surfaces of the body 4; and a pair of external electrodes (a first external electrode 6 and a second external electrode 7), as shown in FIGS. 1 to 5. As shown in FIGS. 2 to 6, the coil part 3 includes the first wiring layer 20 provided on one end face of the substrate 2 in the thickness direction, the second wiring layer 25 provided on the other end face of the substrate 2, and a conducting part 30 electrically connecting the first wiring layer 20 and the second wiring layer 25 through a via hole 13 provided in the substrate 2. The coil part 3 further includes a first base layer 41 between the substrate 2 and the first wiring layer 20, a second base layer 42 between the substrate 2 and the second wiring layer 25, and a first insulating layer 51 and a second insulating layer 52 covering the surfaces of the conducting part 30.

In this specification, for ease of description, the X, Y, and X directions of the electronic component 1 are defined. As shown in FIG. 1, the X direction is a direction (hereinbelow, a lateral direction) perpendicular to the vertical direction of the electronic component 1. The Y direction is a lateral direction of the electronic component 1 and is a direction perpendicular to the X direction. The Z direction is the vertical direction of the electronic component 1. The thickness direction of the substrate 2 is equal to the Z direction. Hereinbelow, the thickness direction of the substrate 2 may be simply referred to as the “substrate thickness direction” or the “thickness direction”.

The substrate 2 is an insulating substrate on which the coil part 3 is formed. More specifically, as shown in FIGS. 2 and 3, the substrate 2 includes a first substrate face 11 on which the first wiring layer 20 of the coil part 3 is formed, and a second substrate face 12 on which the second wiring layer 25 of the coil part 3 is formed. The first substrate face 11 is one end face of two end faces of the substrate 2 in the substrate thickness direction. The second substrate face 12 is the other end face of the two end faces of the substrate 2 and is an end face different from the first substrate face 11 (an end face opposite to the first substrate face 11 in the substrate thickness direction). As shown in FIGS. 3 and 6, the substrate 2 has the via hole 13 for electrically connecting the first wiring layer 20 and the second wiring layer 25 of the coil part 3. The via hole 13 is provided in a predetermined region of the substrate 2, the region overlapping both a first via pad portion 21 of the first wiring layer 20 and a second via pad portion 26 of the second wiring layer 25 in the substrate thickness direction, so as to extend through the substrate 2. The shape of the via hole 13 is not particularly limited, and may be a circular shape, an oval shape such as an elliptical shape or a rounded rectangular shape, or a rectangular shape in plan view as viewed in the substrate thickness direction.

Although the substrate 2 may be a rigid substrate, such as a glass epoxy substrate, it is preferably a flexible substrate from the standpoint of reducing the size of the coil part 3. Examples of the constituent material of the substrate 2 include insulating materials, such as polyimide and paraxylene-based polymer (parylene).

The coil part 3 is a conductor unit having an annular shape in plan view as viewed in the substrate thickness direction, and is disposed inside the body 4, as shown in FIG. 1. More specifically, as shown in FIGS. 2 and 3, the coil part 3 includes the first wiring layer 20 provided on the first substrate face 11, the second wiring layer 25 provided on the second substrate face 12, and the conducting part 30 electrically connecting the first wiring layer 20 and the second wiring layer 25.

As shown in FIGS. 2 to 4, the first wiring layer 20 is a conductor layer having a coil pattern and formed on the first substrate face 11 of the substrate 2. More specifically, as shown in FIGS. 2 to 4, the first wiring layer 20 is formed on the first substrate face 11 by performing metal plating on the base layer (the first base layer 41 shown in FIG. 6) formed in a coil pattern on the first substrate face 11. As shown in, for example, FIG. 4, the coil pattern of the first wiring layer 20 has a spiral shape in plan view as viewed in the substrate thickness direction (the direction orthogonal to the plane of drawing of FIG. 4). The spiral shape has multiple turns around a center axis (not shown) parallel to the Z direction (see FIG. 1) of the electronic component 1. Examples of the conductor constituting the first wiring layer 20 include metals such as copper and iron, and alloys containing at least one of these metals. For ease of forming the coil pattern, the first wiring layer 20 is preferably a conductor layer containing copper.

As shown in FIGS. 2 to 4, the first wiring layer 20 includes the first via pad portion 21. The first via pad portion 21 is a region of the first wiring layer 20, the region including the via hole 13 in the substrate 2 in plan view as viewed in the substrate thickness direction. The first via pad portion 21 constitutes one end (for example, the inner circumferential end of the spiral coil pattern) of the first wiring layer 20 in the wiring direction, as shown in FIG. 4. In the first embodiment, the wiring direction of the first wiring layer 20 corresponds to the longitudinal direction (spiral direction) of the spiral coil pattern. As shown in FIG. 4, the first via pad portion 21 is provided with a first cavity 23. As shown in FIG. 6, the first via pad portion 21 surrounds, inside the first cavity 23, the opening of the via hole 13 on the first substrate face 11 side. At this time, in plan view as viewed in the substrate thickness direction, the first cavity 23 in the first via pad portion 21 includes the entire area of the via hole 13, and preferably coincides with the via hole 13.

The first via pad portion 21 may be formed in a circular shape or the like in plan view as viewed in the substrate thickness direction, and may thus has a width larger than the wiring width of the first wiring layer 20. However, from the standpoint of reducing magnetic flux loss of the coil part 3, the first via pad portion 21 preferably has a maximum width that is smaller than or equal to the wiring width of the first wiring layer 20, as shown in, for example, FIG. 4. In addition, from the standpoint of reducing the electric resistance (direct-current resistance) between the first wiring layer 20 and the second wiring layer 25 of the coil part 3, the first cavity 23 in the first via pad portion 21 preferably has a maximum opening area up to the area of the first via pad portion 21 (the area of the first via pad portion 21 in plan view as viewed in the substrate thickness direction), as shown in, for example, FIG. 4.

As shown in FIGS. 2 and 4, the first wiring layer 20 includes a first connection end 22. The first connection end 22 is the end opposite from the first via pad portion 21 in the wiring direction of the first wiring layer 20, and is an outer circumferential end of the spiral coil pattern as shown in, for example, FIG. 4. As shown in, for example, FIGS. 2 and 4, the first connection end 22 is exposed from one side surface (one end face in the X direction) of the body 4, and is electrically connected to the first external electrode 6 provided on this side surface.

As shown in FIGS. 2, 3, and 5, the second wiring layer 25 is a conductor layer having a coil pattern and formed on the second substrate face 12 of the substrate 2. More specifically, as shown in FIGS. 2, 3, and 5, the second wiring layer 25 is formed on the second substrate face 12 by performing metal plating on the base layer (the second base layer 42 shown in FIG. 6) formed in a coil pattern on the second substrate face 12. As shown in, for example, FIG. 5, the coil pattern of the second wiring layer 25 has a spiral shape having multiple turns around the center axis parallel to the Z direction of the electronic component 1 in plan view as viewed in the substrate thickness direction (the direction orthogonal to the plane of drawing of FIG. 5). More specifically, the coil pattern of the second wiring layer 25 has a spiral shape obtained by reversing the coil pattern of the first wiring layer 20 shown in FIG. 4 in the X direction of the electronic component 1 (the horizontal direction in the plane of drawing of FIG. 4). The second wiring layer 25 is made of the same conductor as the first wiring layer 20.

As shown in FIGS. 2, 3, and 5, the second wiring layer 25 includes the second via pad portion 26 corresponding to the first via pad portion 21 of the first wiring layer 20. The second via pad portion 26 is a region of the second wiring layer 25, the region including the via hole 13 in the substrate 2 and overlapping the first via pad portion 21 of the first wiring layer 20 in plan view as viewed in the substrate thickness direction. As shown in FIG. 5, the second via pad portion 26 constitutes one end (for example, the inner circumferential end of the spiral coil pattern) of the second wiring layer 25 in the wiring direction. In the first embodiment, the wiring direction of the second wiring layer 25 is the longitudinal direction (spiral direction) of the spiral coil pattern. As shown in FIG. 5, the second via pad portion 26 is provided with a second cavity 28. As shown in FIG. 6, the second via pad portion 26 surrounds, inside the second cavity 28, the opening of the via hole 13 on the second substrate face 12 side. At this time, like the first cavity 23 in the first via pad portion 21, in plan view as viewed in the substrate thickness direction, the second cavity 28 in the second via pad portion 26 includes the entire area of the via hole 13, and preferably coincides with the via hole 13.

The second via pad portion 26 may have a width larger than the wiring width of the second wiring layer 25, as in the case of the first via pad portion 21. However, from the standpoint of reducing the magnetic flux loss of the coil part 3, the second wiring layer 25 preferably has a maximum width that is smaller than or equal to the wiring width of the second wiring layer 25, as shown in, for example, FIG. 5. In addition, from the standpoint of reducing the electric resistance between the first wiring layer 20 and the second wiring layer 25 of the coil part 3, the second cavity 28 in the second via pad portion 26 preferably has a maximum opening area up to the area of the second via pad portion 26 (the area of the second via pad portion 26 in plan view as viewed in the substrate thickness direction), as shown in, for example, FIG. 5.

As shown in FIGS. 2 and 5, the second wiring layer 25 includes a second connection end 27. The second connection end 27 is the end opposite from the second via pad portion 26 in the wiring direction of the second wiring layer 25, and is an outer circumferential end in the spiral coil pattern as shown in, for example, FIG. 5. As shown in, for example, FIGS. 2 and 5, the second connection end 27 is exposed from one side surface (the side surface opposite from the first connection end 22) of the body 4 in the X direction, and is electrically connected to the second external electrode 7 provided on this side surface.

The number of turns (the number of windings) and the wiring width of the coil part 3, including the first wiring layer 20 and the second wiring layer 25, are set in accordance with the characteristics, such as electric resistance and inductance, required for the electronic component 1. Specifically, the coil patterns of the first wiring layer 20 and the second wiring layer 25 are set in accordance with the above-mentioned characteristics required for the electronic component 1.

The conducting part 30 covers the surfaces of the first wiring layer 20 and the second wiring layer 25 of the coil part 3 and electrically connects the first wiring layer 20 and the second wiring layer 25 through the via hole 13 in the substrate 2. More specifically, as shown in FIGS. 2 to 6, the conducting part 30 includes a first coating layer 31 covering the surfaces of the first wiring layer 20, a second coating layer 32 covering the surfaces of the second wiring layer 25, and a via conductor part 33 that fills the via hole 13.

The first coating layer 31 is formed on the surfaces of the first wiring layer 20, as shown in FIGS. 2 to 4, by performing metal plating using, as the base layer, the first wiring layer 20 having a coil pattern and formed on the first substrate face 11 of the substrate 2. As a result, the first coating layer 31 having the same coil pattern (see FIG. 4) as the first wiring layer 20 covers the surfaces of the first wiring layer 20. The second coating layer 32 is formed on the surfaces of the second wiring layer 25, as shown in FIGS. 2, 3, and 5, by performing metal plating using, as the base layer, the second wiring layer 25 having a coil pattern and formed on the second substrate face 12 of the substrate 2. As a result, the second coating layer 32 having the same coil pattern (see FIG. 5) as the second wiring layer 25 covers the surface of the second wiring layer 25. The surfaces of the first wiring layer 20 and the second wiring layer 25 include surfaces (e.g., upper surfaces) intersecting the Z-direction, and surfaces (e.g., side surfaces) intersecting the X direction or the Y direction.

As shown in FIG. 3, the via conductor part 33 is formed so as to be integral with the first coating layer 31 and the second coating layer 32 by filling the via hole 13 in the substrate 2 with metal plating when the first coating layer 31 and the second coating layer 32 are formed. More specifically, as shown in FIG. 6, the via conductor part 33 includes a conductor part filling the first cavity 23 in the first wiring layer 20, a conductor part filling the second cavity 28 in the second wiring layer 25, and a conductor part filling the via hole 13. The via conductor part 33 electrically connects the first coating layer 31 on the first wiring layer 20 and the second coating layer 32 on the second wiring layer 25 through these conductor parts. Specifically, the conducting part 30 is in contact with one end (the first via pad portion 21 shown in FIG. 6) of the spiral first wiring layer 20 and one end (the second via pad portion 26 shown in FIG. 6) of the spiral second wiring layer 25 through the via hole 13 to electrically connect the first wiring layer 20 and the second wiring layer 25.

The via conductor part 33 may be formed of metal plating grown from the surface of the first wiring layer 20, metal plating grown from the surface of the second wiring layer 25, or a combination of these two portions of metal plating. Examples of the conductor constituting the conducting part 30 including the first coating layer 31, the second coating layer 32, and the via conductor part 33 include metals such as copper and iron, and alloys containing at least one of these metals. For ease of forming metal plating, like the first wiring layer 20 and the second wiring layer 25, the conducting part 30 is preferably a conductor layer containing copper.

As shown in FIG. 6, the coil part 3 includes the first base layer 41 and the second base layer 42. The first base layer 41 and the second base layer 42 are the base layers used when metal plating is performed on the first substrate face 11 and the second substrate face 12 of the substrate 2, respectively. More specifically, as shown in FIG. 6, the first base layer 41 is formed on the first substrate face 11 and is located between the first substrate face 11 and the first wiring layer 20. For ease of forming the first wiring layer 20 and the first coating layer 31, the first base layer 41 preferably has the same coil pattern as the first wiring layer 20. As shown in FIG. 6, the second base layer 42 is formed on the second substrate face 12 and is located between the second substrate face 12 and the second wiring layer 25. For ease of forming the second wiring layer 25 and the second coating layer 32, the second base layer 42 preferably has the same coil pattern as the second wiring layer 25.

Examples of the conductor constituting the first base layer 41 and the second base layer 42 include metals, such as nickel, chromium, titanium, and copper, and alloys containing at least one of these metals. In particular, the first base layer 41 and the second base layer 42 is preferably a conductor layer containing at least one of nickel, chromium, or titanium.

As shown in FIGS. 2, 3, and 6, the coil part 3 further includes the first insulating layer 51 and the second insulating layer 52 covering the surfaces of the conducting part 30 and the substrate 2. In FIGS. 4 and 5, for ease of description, the first insulating layer 51 and the second insulating layer 52 are not shown. The first insulating layer 51 covers the surfaces of the first coating layer 31 of the conducting part 30 and the surface of the substrate 2 (for example, a portion of the first substrate face 11 located opposite from the second connection end 27 on the second substrate face 12). As shown in FIGS. 2 and 3, the first insulating layer 51 insulates between portions of the first coating layer 31 adjacent to each other along the spiral first wiring layer 20 on the first substrate face 11 of the substrate 2. The second insulating layer 52 covers the surfaces of the second coating layer 32 of the conducting part 30 and the surface of the substrate 2 (for example, a portion of the second substrate face 12 located opposite from the first connection end 22 on the first substrate face 11). As shown in FIGS. 2 and 3, the second insulating layer 52 insulates between portions of the second coating layer 32 adjacent to each other along the spiral second wiring layer 25 on the second substrate face 12 of the substrate 2. Examples of the constituent material of the first insulating layer 51 and the second insulating layer 52 include an insulating material such as parylene.

The body 4 contains a magnetic powder and encloses the coil part 3, as shown in FIG. 1. More specifically, the body 4 is made of an insulating resin containing a magnetic powder (i.e., a magnetic material) and has a three-dimensional structure, such as a rectangular parallelepiped or a cube, as shown in FIG. 1. Examples of the magnetic powder contained in the body 4 include a metal powder such as iron powder and an alloy powder containing a metal such as iron. Examples of the insulating resin containing the magnetic powder include a thermosetting resin, such as an epoxy resin.

As shown in, for example, FIG. 2, the body 4 encloses the coil part 3 in such a manner that the first connection end 22 of the first wiring layer 20 and the second connection end 27 of the second wiring layer 25 are exposed from the side surfaces, which are end faces of the electronic component 1 in the X direction. As shown in FIG. 2, the first connection end 22 connects the first wiring layer 20 and the first external electrode 6, and the second connection end 27 connects the second wiring layer 25 and the second external electrode 7. As shown in FIGS. 2 to 5, the body 4 is present in an inner region surrounded by the coil part 3 and is wound by the coil part 3. The body 4 serves both as a structure (housing) enclosing the coil part 3, as described above, and a magnetic core.

The exterior coating 5 covers, of the outer surfaces of the body 4 described above, regions other than the regions provided with the external electrode. For example, the exterior coating 5 is made of an insulating resin such as an epoxy resin, and is provided on the outer surface of the body 4 so as to cover the regions other than the regions provided with the first external electrode 6 and the second external electrode 7, of the upper surface, the lower surface, and the side surfaces of the body 4, as shown in FIGS. 1 to 5.

As shown in FIG. 1, the first external electrode 6 and the second external electrode 7 are a pair of external electrodes provided on the outer surfaces of the body 4 and electrically connected to the coil part 3 inside the body 4. As shown in FIG. 2, for example, the first external electrode 6 is provided to have an L-shaped cross section on the outer surface of the body 4, in a region extending from one side surface (hereinbelow, a first side surface) in the X direction to a part of the lower surface. The first external electrode 6 is electrically connected to the first connection end 22 of the first wiring layer 20 exposed on the first side surface of the body 4. As shown in FIG. 2, the second external electrode 7 is provided to have an L-shaped cross section, so as to form a pair with the first external electrode 6 with a space therebetween, on the outer surface of the body 4, in a region extending from the other side surface (hereinbelow, a second side surface) in the X direction to a portion of the lower surface. The second side surface is located on the opposite side from the first side surface in the X direction. The second external electrode 7 is electrically connected to the second connection end 27 of the second wiring layer 25 exposed on the second side surface of the body 4.

Examples of the conductor constituting the first external electrode 6 and the second external electrode 7 include metals such as copper, tin, and nickel, and alloys containing these metals. Each of the first external electrode 6 and the second external electrode 7 may be formed of a single conductor layer or a plurality of conductor layers.

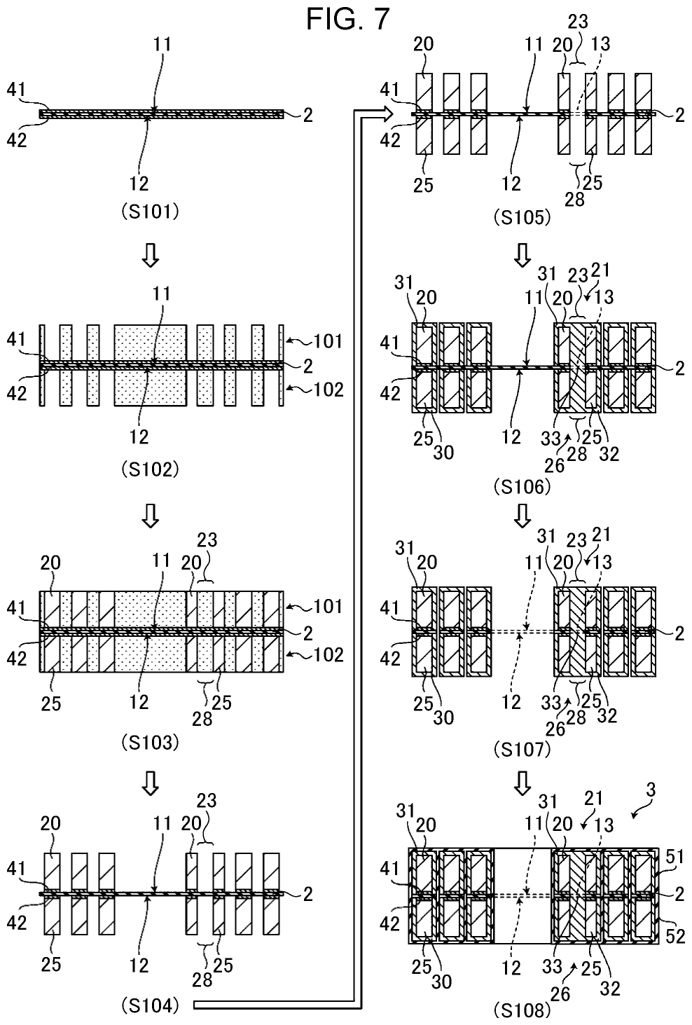

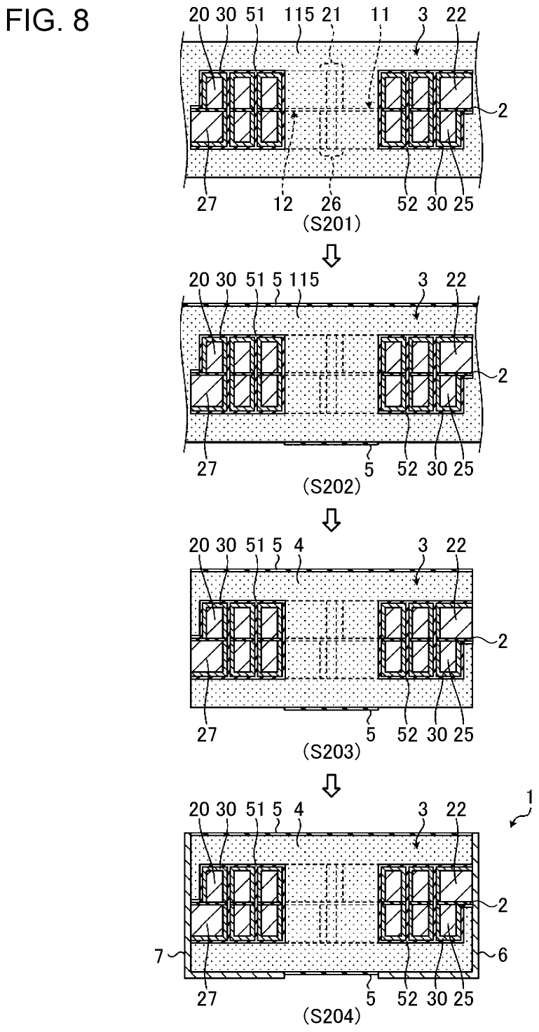

Next, a method for manufacturing the electronic component 1 according to the first embodiment will be described. FIG. 7 is a flow diagram showing an example method for producing the coil part according to the first embodiment. FIG. 7 is a flow diagram viewed from the same viewpoint (X direction) as in FIG. 3, which is a schematic sectional view of the electronic component 1 taken along line III-III in FIG. 1). FIG. 8 is a flow diagram showing an example method for manufacturing an electronic component including a coil part according to the first embodiment. FIG. 8 is a flow diagram viewed from the same viewpoint (Y direction) as in FIG. 2, which is a schematic sectional view of the electronic component 1 taken along line II-II in FIG. 1). By sequentially performing the steps shown in FIG. 7, the above-described coil part 3 (see FIGS. 2 to 6) is produced. Subsequently, by sequentially performing the steps shown in FIG. 8, the electronic component 1 (see FIG. 1) including the above-described coil part 3 is manufactured.

In the method for manufacturing the electronic component 1, as shown in FIG. 7, first, to produce the coil part 3, a base layer forming step of forming base layers on the first substrate face 11 and the second substrate face 12 of the substrate 2 is performed (step S101).

In the base layer forming step S101, a conductor film is formed by sputtering or the like on each end face in the thickness direction of the substrate 2 that has been transported into a device such as a vacuum chamber. Examples of the conductor include nickel (Ni), chromium (Cr), titanium (Ti), and copper (Cu). Examples of the conductor film include films containing at least one of nickel, chromium, titanium, and copper, such as a Ni—Cr film, a Ni—Cr—Cu film, and a Ni—Ti film. Among these, a film (conductor layer) containing at least one of nickel, chromium, or titanium is preferable. Thus, as shown in FIG. 7, the first base layer 41 is formed on the first substrate face 11 of the substrate 2, and the second base layer 42 is formed on the second substrate face 12 of the substrate 2.

The order of forming the first base layer 41 and the second base layer 42 is not particularly limited. The second base layer 42 may be formed after the first base layer 41 is formed. The first base layer 41 may be formed after the second base layer 42 is formed. The first base layer 41 and the second base layer 42 may be formed simultaneously.

After the base layer forming step S101, a pattern forming step of forming a coil pattern on the base layer (first base layer 41) on the first substrate face 11 and the base layer (second base layer 42) on the second substrate face 12 of the substrate 2 is performed (step S102).

In the pattern forming step S102, as shown in FIG. 7, a first resist 101 is formed on the first base layer 41 on the first substrate face 11, and a second resist 102 is formed on the second base layer 42 on the second substrate face 12. For example, the first resist 101 and the second resist 102 may be formed by laminating a dry film or by applying a photoresist. The order of forming the first resist 101 and the second resist 102 is not particularly limited. Whichever one of these resists may be formed first, or these resists may be formed simultaneously. The thus-formed first resist 101 and the second resist 102 are subjected to treatments such as exposure and development. As a result, a desired coil pattern is formed, as shown in FIG. 7.

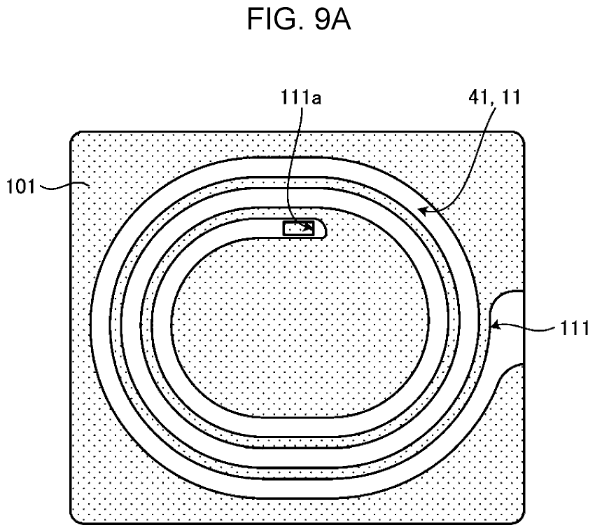

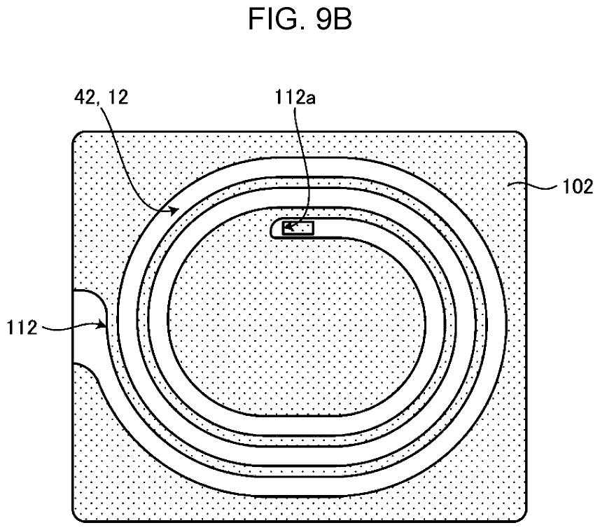

FIG. 9A schematically shows an example coil pattern formed on the first base layer on the first substrate face. FIG. 9B schematically shows an example coil pattern formed on the second base layer on the second substrate face. As shown in FIG. 9A, the first resist 101 that has been subjected to the above-described treatment forms a first coil pattern 111 having a spiral shape in plan view as viewed in the substrate thickness direction (a direction orthogonal to the plane of drawing of FIG. 9A) on the first base layer 41 on the first substrate face 11. The inner circumferential end of the spiral first coil pattern 111 includes a first opening pattern 111a for forming the first cavity 23 in the first via pad portion 21 of the first wiring layer 20 shown in FIG. 4. As shown in FIG. 9B, the second resist 102 that has been subjected to the above-described treatment forms a second coil pattern 112 having a spiral shape in plan view as viewed in the substrate thickness direction (a direction orthogonal to the plane of drawing of FIG. 9B) on the second base layer 42 on the second substrate face 12. The inner circumferential end of the spiral second coil pattern 112 includes a second opening pattern 112a for forming the second cavity 28 in the second via pad portion 26 of the second wiring layer 25 shown in FIG. 5.

After the pattern forming step S102, a first plating step of forming the first wiring layer 20 having the first coil pattern 111 on the first substrate face 11 of the substrate 2 and forming the second wiring layer 25 having the second coil pattern 112 on the second substrate face 12 of the substrate 2 is performed (step S103).

In the first plating step S103, as shown in FIG. 7, the surface of the first base layer 41 having the first coil pattern 111 (see FIG. 9A) on the first substrate face 11 of the substrate 2 is plated. Thus, the first wiring layer 20 having the first coil pattern 111 is formed on the surface of the first base layer 41. As shown in, for example, FIG. 7, the thus-formed first wiring layer 20 has the first cavity 23 that extends to the first substrate face 11, corresponding to the first opening pattern 111a in the first coil pattern 111. In parallel with the formation of the first wiring layer 20, the surface of the second base layer 42 having the second coil pattern 112 (see FIG. 9B) on the second substrate face 12 of the substrate 2 is plated. Thus, the second wiring layer 25 having the second coil pattern 112 is formed on the surface of the second base layer 42. As shown in, for example, FIG. 7, the thus-formed second wiring layer 25 has the second cavity 28 that extends to the second substrate face 12, corresponding to the second opening pattern 112a in the second coil pattern 112. As shown in FIG. 7, the second cavity 28 is provided at a position overlapping the first cavity 23 in the substrate thickness direction (the vertical direction in the plane of drawing of FIG. 7).

Examples of the plating treatment performed in the first plating step include metal plating using copper, iron, or the like, and alloy plating using an alloy containing a metal such as copper or iron. Among these, for ease of forming the first wiring layer 20 and the second wiring layer 25, copper plating or alloy plating using an alloy containing copper is preferable.

After the first plating step S103, a removal step of removing unnecessary base layers and resists from the substrate 2 is performed (step S104). In the removal step S104, as shown in FIG. 7, the first resist 101 and the second resist 102 are removed from the first substrate face 11 and the second substrate face 12 of the substrate 2, respectively, by peeling, etching, or the like. Next, portions of the first base layer 41 and the second base layer 42 exposed by removing the first resist 101 and the second resist 102 are removed from the first substrate face 11 and the second substrate face 12 by etching or the like. As a result, the first base layer 41 located between the first substrate face 11 and the first wiring layer 20 and the second base layer 42 located between the second substrate face 12 and the second wiring layer 25 remain on the substrate 2. The first base layer 41 has the same coil pattern as the first wiring layer 20, and the second base layer 42 has the same coil pattern as the second wiring layer 25. For convenience of description, FIG. 7 shows only a cross-section of the first wiring layer 20, the second wiring layer 25, the first base layer 41, and the second base layer 42 as viewed in the X direction.

After the removal step S104, a via hole forming step of forming the via hole 13 in the substrate 2 is performed (step S105). In the via hole forming step S105, as shown in FIG. 7, the via hole 13 is formed so as to extend through the substrate 2 inside the first cavity 23 in the first wiring layer 20 and the second cavity 28 in the second wiring layer 25. As shown in FIG. 7, the thus-formed via hole 13 preferably has the same inner diameter as the first cavity 23 and the second cavity 28 to form a continuous through hole with the first cavity 23 and the second cavity 28.

For example, in the via hole forming step S105, the via hole 13 may be formed in the substrate 2 by laser processing. In that case, of the substrate 2, inner regions surrounded by the first cavity 23 and the second cavity 28 are irradiated with a laser beam to be melt and removed. As a result, the via hole 13 is formed in the substrate 2.

In the via hole forming step S105, the via hole 13 may be formed in the substrate 2 by etching. In that case, in the substrate 2, the overall area other than the inner regions surrounded by the first cavity 23 and the second cavity 28 is covered with an etching mask, and wet etching, in which the inner regions and an etchant are brought into contact with each other, is performed to corrode (dissolve) and remove the inner regions. As a result, the via hole 13 is formed in the substrate 2. The etching mask is removed from the substrate 2 after the via hole 13 is formed. For example, the etching mask may be formed by laminating a dry film or by applying a photoresist.

After the via hole forming step S105, a second plating step of plating the surfaces of the first wiring layer 20 and the second wiring layer 25 to form the conductor layer, and filling the via hole 13 with a via conductor part grown from the conductor layer is performed to electrically connect the first wiring layer 20 and the second wiring layer 25 (step S106).

In the second plating step S106, as shown in FIG. 7, the surfaces of the first wiring layer 20 formed on the first substrate face 11 of the substrate 2 are plated to form the first coating layer 31, which is a conductor layer covering the surfaces of the first wiring layer 20, and the surfaces of the second wiring layer 25 formed on the second substrate face 12 of the substrate 2 are plated to form the second coating layer 32, which is a conductor layer covering the surfaces of the second wiring layer 25. At the same time, the via hole 13 in the substrate 2 is filled with the via conductor part 33 grown from at least one of the first coating layer 31 and the second coating layer 32 through the first cavity 23 in the first wiring layer 20 and the second cavity 28 in the second wiring layer 25. As a result, as shown in FIG. 7, the conducting part 30 covering the surfaces of the first wiring layer 20 and the second wiring layer 25 and electrically connecting the first wiring layer 20 and the second wiring layer 25 through the via hole 13, is formed. For convenience of description, FIG. 7 shows only a cross-section of the conducting part 30 as viewed in the X direction.

Examples of the plating treatment for the first coating layer 31 and the second coating layer 32 include metal plating using copper, iron, or the like and alloy plating using an alloy containing a metal such as copper or iron. Among these, copper plating or alloy plating using an alloy containing copper is preferable, as in the case of the first wiring layer 20 and the second wiring layer 25 described above.

After the second plating step S106, a substrate removal step of removing some regions of the substrate 2 is performed (step S107). In the substrate removal step S107, for example, the conductor layers, such as the first wiring layer 20 and the second wiring layer 25, formed on the substrate 2 are used as etching masks to keep regions of the substrate 2 necessary for the presence of the first wiring layer 20 and the second wiring layer 25 and to remove, by etching, regions where the first wiring layer 20 and the second wiring layer 25 do not exist. As a result, as shown in FIG. 7, the substrate 2 has the same shape as the shape obtained by projecting the first wiring layer 20 and the second wiring layer 25 in the substrate thickness direction.

Examples of the necessary regions include a region in the first substrate face 11 where the first wiring layer 20 is formed, a region in the second substrate face 12 where the second wiring layer 25 is formed, and the like. The regions of the substrate 2 to be removed by etching include a region surrounded by the spiral first wiring layer 20 and the second wiring layer 25, a region outside the first wiring layer 20 and the second wiring layer 25, a region between adjacent portions of the first wiring layer 20 on the first substrate face 11, and a region between adjacent portions of the second wiring layer 25 on the second substrate face 12. The region between adjacent portions of the first wiring layer 20 and the region between adjacent portions of the second wiring layer 25 may be kept by, for example, covering the regions with an etching mask.

After the substrate removal step S107, a covering step of covering the surfaces of the conducting part 30 and the substrate 2 with an insulating layer is performed (step S108). In the covering step S108, regions of the surfaces of the conducting part 30 on the first substrate face 11 side of the substrate 2 (e.g., the surfaces of the first coating layer 31 and the upper end face of the via conductor part 33) and a region where the substrate 2 is exposed (e.g., an exposed portion of the first substrate face 11 due to the lack of the conductor layer such as the first wiring layer 20) are covered with an insulating material such as parylene. By doing so, as shown in FIG. 7, the first insulating layer 51 covering the exposed region of the substrate 2 and the surfaces of the conducting part 30 on the first substrate face 11 side is formed. In addition, regions of the surfaces of the conducting part 30 on the second substrate face 12 side of the substrate 2 (e.g., the surfaces of the second coating layer 32 and the lower end face of the via conductor part 33) and a region where the substrate 2 is exposed (e.g., an exposed portion of the second substrate face 12 due to the lack of the conductor layer such as the second wiring layer 25) are covered with an insulating material such as parylene. By doing so, as shown in FIG. 7, the second insulating layer 52 covering the exposed region of the substrate 2 and the surfaces of the conducting part 30 on the second substrate face 12 side is formed. Through these steps, the coil part 3 including the first wiring layer 20, the second wiring layer 25, and the conducting part 30 is produced.

Subsequently, as shown in FIG. 8, a sealing step of embedding the coil part 3, together with the substrate 2, in a magnetic substance is performed (step S201). In the sealing step S201, the substrate 2 and the coil part 3 are set in a device such as a mold, and a magnetic material is injected, with pressure into the device and cured. As a result, as shown in FIG. 8, a molded body of a magnetic material 115 that seals the coil part 3, together with the substrate 2, is produced. In this molded body, the magnetic material 115 fills an inner region surrounded by the first wiring layer 20 and the second wiring layer 25 of the coil part 3, an outer region of the coil part 3, regions between portions of the first insulating layer 51 and portions of the second insulating layer 52 in the coil part 3, and the like.

The magnetic material 115 may be a mixture of a magnetic powder and an insulating resin. Examples of the magnetic powder include a metal powder such as iron powder and an alloy powder containing a metal such as iron. Examples of the insulating resin include a thermosetting resin, such as an epoxy resin.

After the sealing step S201, an exterior coating step of providing an exterior coating 5 on the outer surface of the molded body of the magnetic material 115 is performed (step S202). In the exterior coating step S202, the molded body of the magnetic material 115 is diced along the X direction. This provides the molded body with a pair of side surfaces facing each other in the Y direction (the direction orthogonal to the plane of drawing of FIG. 8) with the coil part 3 therebetween. Subsequently, the pair of side surfaces and the upper and lower surfaces of the molded body are coated with an insulating resin, such as epoxy resin. In this way, as shown in FIG. 8, the exterior coating 5 is formed on the outer surfaces of the molded body. For example, the exterior coating 5 is provided on the outer surfaces of the molded body, in regions other than the regions where the first external electrode 6 and the second external electrode 7 are to be formed in step S204, i.e., the upper surface, the pair of side surfaces facing each other in the Y direction, and a part of the lower surface.

After the exterior coating step S202, a dicing step of dicing the molded body of the magnetic material 115 is performed (step S203). In the dicing step S203, the molded body of the magnetic material 115 is diced into bodies 4 each enclosing the coil part 3, as shown in FIG. 8. At this time, as shown in FIG. 8, the body 4 encloses the coil part 3 in a state in which the first connection end 22 of the first wiring layer 20 and the second connection end 27 of the second wiring layer 25 are exposed from a pair of side surfaces in the X direction (the horizontal direction in the plane of drawing of FIG. 8). The exterior coating 5, formed in the exterior coating step S202, is provided on the upper surface, a pair of side surfaces facing each other in the Y direction, and a part of the lower surface of the body 4.

After the dicing step S203, an electrode forming step of forming, on the outer surfaces of the body 4 (step S204), a pair of external electrodes electrically connected to the coil part 3 is performed. In the electrode forming step S204, exposed regions of the outer surfaces of the body 4 where the exterior coating 5 is not formed are plated with a metal such as Cu, Sn, or Ni, or an alloy containing any of these metals. As a result, as shown in FIG. 8, the first external electrode 6 and the second external electrode 7 are formed on the exposed regions. For example, the first external electrode 6 is provided to have an L-shaped cross section on the outer surface of the body 4, in a region extending from the first side surface in the X direction to a portion of the lower surface, and is electrically connected to the first connection end 22 exposed from the first side surface. The second external electrode 7 is provided to have an L-shaped cross section on the outer surface of the body 4, in a region extending from the second side surface in the X direction to a portion of the lower surface, and is electrically connected to the second connection end 27 exposed from the second side surface. As shown in FIG. 8, the exterior coating 5 is disposed between the first external electrode 6 and the second external electrode 7. This ensures insulation between the first external electrode 6 and the second external electrode 7. Through the above-described process, the electronic component 1 according to the first embodiment is manufactured.

As described above, the electronic component 1 according to the first embodiment includes the substrate 2 and the coil part 3 having an annular shape in plan view as viewed in the substrate thickness direction. The coil part 3 includes the first wiring layer 20 having a coil pattern and formed on the first substrate face 11, which is one end face of the substrate 2 in the substrate thickness direction, the second wiring layer 25 having a coil pattern and formed on the second substrate face 12, which is the other end face of the substrate 2 in the substrate thickness direction, and the conducting part 30 electrically connecting the first wiring layer 20 and the second wiring layer 25. In the electronic component 1, the conducting part 30 covers the surfaces of the first wiring layer 20 and the second wiring layer 25 and electrically connects the first wiring layer 20 on the first substrate face 11 and the second wiring layer 25 on the second substrate face 12 through the via hole 13 extending through the substrate 2.

Hence, there is no need to provide a margin between ends of the first wiring layer 20 and the second wiring layer 25 in the width direction and the opening edge of the via hole 13. Thus, it is possible to easily increase the opening area of the via hole 13 and to sufficiently fill the via hole 13 with the via conductor part 33 of the conducting part 30 over the entire circumference of the opening edge of the via hole 13. Thus, the sectional area of the via conductor part 33 of the conducting part 30, which electrically connects the first wiring layer 20 on the first substrate face 11 and the second wiring layer 25 on the second substrate face 12 through the via hole 13, can be increased in accordance with the opening area of the via hole 13. Hence, it is possible to reduce the electric resistance (connection resistance) between the first wiring layer 20 and the second wiring layer 25, and thus to reduce the electric resistance of the coil part 3.

Furthermore, in the electronic component 1 according to the first embodiment, the coil part 3 includes the first via pad portion 21, which constitutes one end of the first wiring layer 20 in the wiring direction and surrounds the opening of the via hole 13 on the first substrate face 11 side, and the second via pad portion 26, which constitutes one end of the second wiring layer 25 in the wiring direction and surrounds the opening of the via hole 13 on the second substrate face 12 side. In the coil part 3, the maximum width of the first via pad portion 21 is set to be smaller than or equal to the wiring width of the first wiring layer 20, and the maximum width of the second via pad portion 26 is set to be smaller than or equal to the wiring width of the second wiring layer 25.

This prevents the first via pad portion 21 and the second via pad portion 26 from extending to the inner regions surrounded by the first wiring layer 20 and the second wiring layer 25, that is, the inner region of the coil part 3. This prevents a decrease in volume of the inner region of the coil part 3. Accordingly, it is possible to prevent a decrease in volume of the magnetic body (the magnetic core formed by the body 4) present in the inner region, and thus to reduce the magnetic flux loss of the coil part 3.

In the method for manufacturing the electronic component according to the first embodiment, in the base layer forming step, base layers are formed on the first substrate face 11 at one end and on the second substrate face 12 at the other end in the thickness direction of the substrate 2. In the pattern forming step, a coil pattern is formed on each of the base layer (first base layer 41) on the first substrate face 11 and the base layer (second base layer 42) on the second substrate face 12. In the first plating step, the surface of the first base layer 41 having the coil pattern on the first substrate face 11 is plated to form the first wiring layer 20 having the first cavity 23 that extends to the first substrate face 11, and the surface of the second base layer 42 having the coil pattern on the second substrate face 12 is plated to form the second wiring layer 25 having the second cavity 28 that extends to the second substrate face 12 at a position overlapping the first cavity 23 in the substrate thickness direction. Subsequently, in the via hole forming step, the via hole 13 extending through the substrate 2 inside the first cavity 23 and the second cavity 28 is formed. In the second plating step, while the surfaces of the first wiring layer 20 and the second wiring layer 25 are plated to form the conductor layers (the first coating layer 31 and the second coating layer 32), the via hole 13 is filled with the via conductor part 33 grown from the conductor layer to electrically connect the first wiring layer 20 and the second wiring layer 25.

Hence, it is possible to reliably provide the via hole 13 in the substrate 2, at the inner region surrounded by the openings (the first cavity 23 and the second cavity 28) in the first wiring layer 20 and the second wiring layer 25. In this way, it is possible to prevent deterioration of the positional relationship between the via hole 13 and the first and second cavities 23 and 28, and to prevent entry of at least one of the first wiring layer 20 and the second wiring layer 25 into the opening region of the via hole 13. As a result, the entire circumference of the opening edge of the via hole 13 can be set to the close vicinity of the inner surfaces of the first cavity 23 and the second cavity 28. Accordingly, it is possible to easily increase the opening area of the via hole 13 and to sufficiently fill the via hole 13 with the via conductor part 33 over the entire circumference of the opening edge of the via hole 13. As a result, the sectional area of the via conductor part 33 can be increased in accordance with the opening area of the via hole 13. Hence, it is possible to reduce the electric resistance between the first wiring layer 20 and the second wiring layer 25 through the via conductor part 33, and consequently, to reduce the electric resistance of the coil part 3.

After the position of the first cavity 23 in the first wiring layer 20 on the first substrate face 11 and the position of the second cavity 28 in the second wiring layer 25 on the second substrate face 12 are determined, the via hole 13 is formed in the substrate 2, at the inner region surrounded by the first cavity 23 and the second cavity 28. This makes it possible to easily increase the opening area of the via hole 13 in accordance with the opening areas of the first cavity 23 and the second cavity 28, even when the maximum width of the first via pad portion 21 of the first wiring layer 20 in which the first cavity 23 is provided is set to be smaller than or equal to the wiring width of the first wiring layer 20, and the maximum width of the second via pad portion 26 of the second wiring layer 25 in which the second cavity 28 is provided is set to be smaller than or equal to the wiring width of the second wiring layer 25. Hence, it is possible to prevent the first via pad portion 21 and the second via pad portion 26 from extending into the inner region of the coil part 3, and thus to prevent a decrease in volume of the inner region of the coil part 3. Accordingly, it is possible to prevent a decrease in volume of the magnetic body present in the inner region, and thus to reduce the magnetic flux loss of the coil part 3.

### Second Embodiment

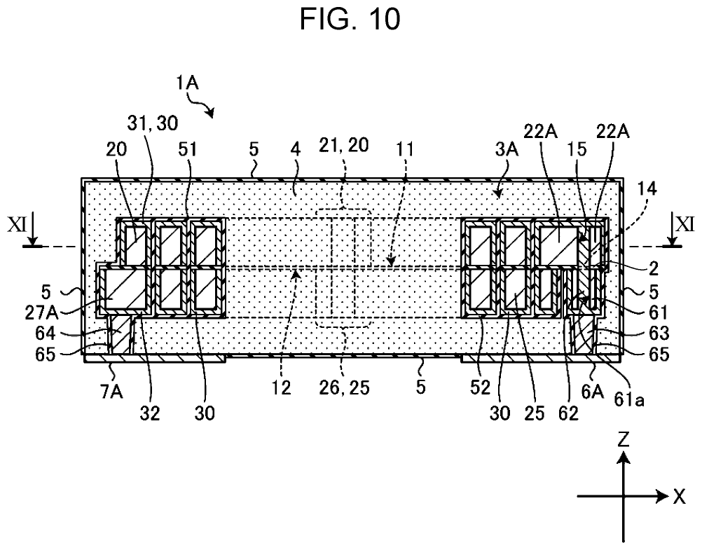

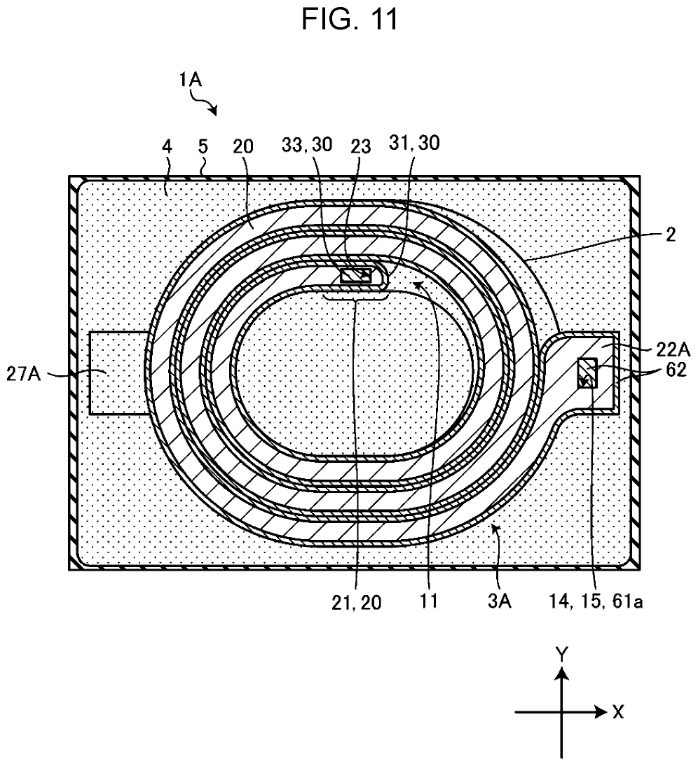

Next, an electronic component according to a second embodiment of the present invention will be described. FIG. 10 is a schematic sectional view showing a configuration example of an electronic component according to the second embodiment. FIG. 10 schematically shows a sectional structure of the electronic component as viewed in the same viewpoint as in FIG. 2. FIG. 11 is a schematic sectional view showing a configuration example of the electronic component in FIG. 10, taken along line XI-XI. As shown in FIGS. 10 and 11, an electronic component 1A according to the second embodiment includes: a coil part 3A instead of the coil part 3 of the electronic component 1 according to the first embodiment; a first external electrode 6A and a second external electrode 7A instead of the first external electrode 6 and the second external electrode 7; and an electrode via hole 14 in the substrate 2. The coil part 3A includes a first connection end 22A and a second connection end 27A instead of the first connection end 22 and the second connection end 27 of the coil part 3 according to the first embodiment, a lead-out wiring part 61, an electrode conducting part 62, a first internal terminal 63, a second internal terminal 64, and an insulating layer 65. The other configurations are the same as those in the first embodiment, and the same reference numerals denote the same components.

As shown in FIGS. 10 and 11, in the coil part 3A, the first connection end 22A of the first wiring layer 20 is not exposed from the body 4, but is located inside the body 4. As shown in, for example, FIG. 10, the first connection end 22A is electrically connected to the first external electrode 6A on the lower surface of the body 4 via the lead-out wiring part 61, the electrode conducting part 62, and the first internal terminal 63. For convenience of description, the first insulating layer 51 is not shown in FIG. 11.

As shown in FIGS. 10 and 11, the first connection end 22A is provided with a cavity 15 that communicates with the electrode via hole 14. The electrode via hole 14 is provided in the substrate 2, at a predetermined region overlapping both the first connection end 22A of the first wiring layer 20 and the lead-out wiring part 61 in the substrate thickness direction, so as to extend through the substrate 2. As shown in FIG. 10, the first connection end 22A surrounds, inside the cavity 15, the opening of the electrode via hole 14 on the first substrate face 11 side. At this time, in plan view as viewed in the substrate thickness direction, the cavity 15 in the first connection end 22A includes the entire area of the electrode via hole 14, and preferably coincides with the electrode via hole 14.

The shapes of the electrode via hole 14 and the cavity 15 are not particularly limited, and may be a circular shape, an oval shape such as elliptical shape or a rounded rectangular, or a rectangular shape in plan view as viewed in the substrate thickness direction. In the second embodiment, the first wiring layer 20 has the same configuration as that in the first embodiment except that the first connection end 22A is provided.

As shown in FIGS. 10 and 11, in the coil part 3A, the second connection end 27A of the second wiring layer 25 is not exposed from the body 4, but is located inside the body 4. As shown in, for example, FIG. 10, the second connection end 27A is electrically connected to the second external electrode 7A on the lower surface of the body 4 via the second internal terminal 64. In the second embodiment, the second wiring layer 25 has the same configuration as that in the first embodiment except that the second connection end 27A is provided.

The lead-out wiring part 61 is a part of a conductor layer for electrically connecting the first wiring layer 20 on the first substrate face 11 and the first external electrode 6A on the lower surface of the body 4. More specifically, as shown in FIG. 10, the lead-out wiring part 61 is formed so as to extend from the second substrate face 12 in the substrate thickness direction (downward in the plane of drawing of FIG. 10), at a position away from the second wiring layer 25, by performing metal plating on a base layer (not shown) formed on the second substrate face 12 of the substrate 2. The base layer of the lead-out wiring part 61 is a part of the base layer of the second wiring layer 25 (the second base layer 42 shown in FIG. 6). The lead-out wiring part 61 is made of the same conductor as the second wiring layer 25. As shown in FIGS. 10 and 11, the lead-out wiring part 61 is provided with a cavity 61a that communicates with the electrode via hole 14. As shown in FIG. 10, the lead-out wiring part 61 surrounds, inside the cavity 61a, the opening of the electrode via hole 14 on the second substrate face 12 side. At this time, the cavity 61a of the lead-out wiring part 61 includes the entire area of the electrode via hole 14 in plan view as viewed in the substrate thickness direction, and preferably coincides with the electrode via hole 14. The shape of the cavity 61a of the lead-out wiring part 61 is not particularly limited, and may be the same as the shapes of the electrode via hole 14 and the cavity 15 described above, for example.

As shown in FIGS. 10 and 11, the electrode conducting part 62 covers the surfaces of the first connection end 22A of the first wiring layer 20 and the surfaces of the lead-out wiring part 61 and electrically connects the first connection end 22A and the lead-out wiring part 61 through the electrode via hole 14 in the substrate 2. More specifically, as shown in FIG. 10, the first connection end 22A is a connection end of the first wiring layer 20, which overlaps the lead-out wiring part 61 in plan view as viewed in the substrate thickness direction. As shown in FIGS. 10 and 11, the electrode conducting part 62 includes a first coating layer covering the surfaces of the first connection end 22A, a second coating layer covering the surfaces of the lead-out wiring part 61, and a via conductor part that fills the electrode via hole 14. The surfaces of the first connection end 22A and the lead-out wiring part 61 include surfaces intersecting the Z direction, and surfaces intersecting the X direction or the Y direction.

As shown in FIGS. 10 and 11, the first coating layer of the electrode conducting part 62 is a part of the first coating layer 31 covering the surfaces of the first wiring layer 20. As shown in FIG. 10, the second coating layer of the electrode conducting part 62 is formed in the same manner as the second coating layer 32 covering the surface of the second wiring layer 25. As shown in FIG. 10, the via conductor part of the electrode conducting part 62 is formed integrally with the first coating layer and the second coating layer of the electrode conducting part 62 by filling the electrode via hole 14 in the substrate 2 with metal plating when the first coating layer 31 and the second coating layer 32 are formed. Specifically, the via conductor part of the electrode conducting part 62 includes a conductor part filling the cavity 15 in the first connection end 22A, a conductor part filling the cavity 61a in the lead-out wiring part 61, and a conductor part filling the electrode via hole 14. The formation of the via conductor part of the electrode conducting part 62 progresses in parallel with the formation of the via conductor part 33 in the via hole 13.

The via conductor part of the electrode conducting part 62 may be formed of metal plating grown from the surface of the first connection end 22A, metal plating grown from the surface of the lead-out wiring part 61, or a combination of the two metal plating. Examples of the conductor constituting the electrode conducting part 62 include metals such as copper and iron, and alloys containing at least one of these metals. For ease of formation of the metal plating, the electrode conducting part 62 is preferably a conductor layer containing copper, as in the case of the conducting part 30.

The first internal terminal 63 is a part of a conductor layer for electrically connecting the first wiring layer 20 on the first substrate face 11 and the first external electrode 6A on the lower surface of the body 4. More specifically, as shown in FIG. 10, the first internal terminal 63 is formed so as to extend from the electrode conducting part 62 in the substrate thickness direction (downward in the plane of drawing of FIG. 10) by performing metal plating using the electrode conducting part 62, formed on the surface of the lead-out wiring part 61, as the base layer. An extending end (lower end) of the first internal terminal 63 is exposed from the lower surface of the body 4. As shown in FIG. 10, the first internal terminal 63 electrically connects the first wiring layer 20 in the body 4 and the first external electrode 6A on the lower surface of the body 4 through the electrode conducting part 62.

The second internal terminal 64 is a part of a conductor layer for electrically connecting the second wiring layer 25 on the second substrate face 12 and the second external electrode 7A on the lower surface of the body 4. More specifically, as shown in FIG. 10, the second internal terminal 64 is formed so as to extend from the second coating layer 32 in the substrate thickness direction (downward in the plane of drawing of FIG. 10) by performing metal plating using the second coating layer 32 of the conducting part 30, formed on the surface of the second wiring layer 25, as the base layer. The extending end (lower end) of the second internal terminal 64 is exposed from the lower surface of the body 4, like the first internal terminal 63. Specifically, the coil part 3A is enclosed in the body 4 in a state in which the extending ends of the first internal terminal 63 and the second internal terminal 64 are exposed from the lower surface of the body 4. As shown in FIG. 10, the second internal terminal 64 electrically connects the second wiring layer 25 inside the body 4 and the second external electrode 7A on the lower surface of the body 4 via the second coating layer 32 of the conducting part 30 covering the surfaces of the second connection end 27A of the second wiring layer 25, which forms a pair with the first connection end 22A.

The first internal terminal 63 and the second internal terminal 64 are made of the same conductor as the electrode conducting part 62. The first internal terminal 63 and the second internal terminal 64 may be formed in a truncated cone shape that decreases in diameter from the coil part 3 toward the lower surface of the body 4, as shown in, for example, FIG. 10, a truncated cone shape that increases in diameter from the coil part 3 toward the lower surface of the body 4, or a columnar shape such as a circular columnar shape or a rectangular columnar shape.

As shown in FIG. 10, the insulating layer 65 covers the surfaces of the electrode conducting part 62, the first internal terminal 63, and the second internal terminal 64. Thus, the insulating layer 65 insulates the electrode conducting part 62, the first internal terminal 63, and the second internal terminal 64 from the body 4. The insulating layer 65 is made of the same material as the first insulating layer 51 and the second insulating layer 52.

As shown in FIG. 10, the first external electrode 6A and the second external electrode 7A are a pair of external electrodes provided on the lower surface of the body 4 and electrically connected to the coil part 3A inside the body 4. As shown in FIG. 10, the first external electrode 6A is provided on the lower surface (one end face in the Z direction) of the body 4, in a region including the region where the extending end of the first internal terminal 63 is exposed; that is, for example, a first lower surface region located at a predetermined distance from the lower end of the first side surface in the X direction. The first external electrode 6A is electrically connected to the first connection end 22A of the first wiring layer 20 via the first internal terminal 63 exposed from the first lower surface region of the body 4. As shown in FIG. 10, the second external electrode 7A is provided on the lower surface of the body 4, in a region including the region where the extending end of the second internal terminal 64 is exposed; that is, for example, a second lower surface region located at a predetermined distance from the lower end of the second side surface in the X direction, so as to form a pair with the first external electrode 6A with a distance therebetween. The second external electrode 7A is electrically connected to the second connection end 27A of the second wiring layer 25 via the second internal terminal 64 exposed in the second lower surface region of the body 4. The first external electrode 6A and the second external electrode 7A are made of the same conductor as the first external electrode 6 and the second external electrode 7 in the first embodiment.

In the second embodiment, the exterior coating 5 covers, of the outer surfaces of the body 4, regions other than the lower surface regions where the first external electrode 6A and the second external electrode 7A are provided. For example, as shown in FIGS. 10 and 11, the exterior coating 5 is provided on the overall area of the upper surface and the side surfaces of the body 4 and, of the lower surface of the body 4, the lower surface region (e.g., the lower surface region between the first lower surface region and the second lower surface region) excluding the first lower surface region and the second lower surface region.

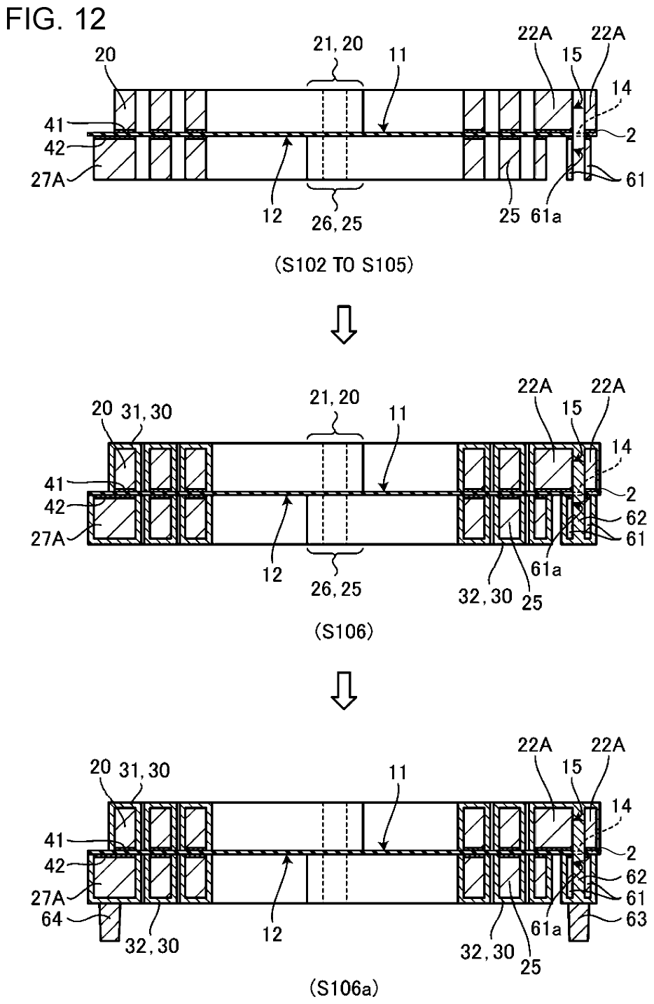

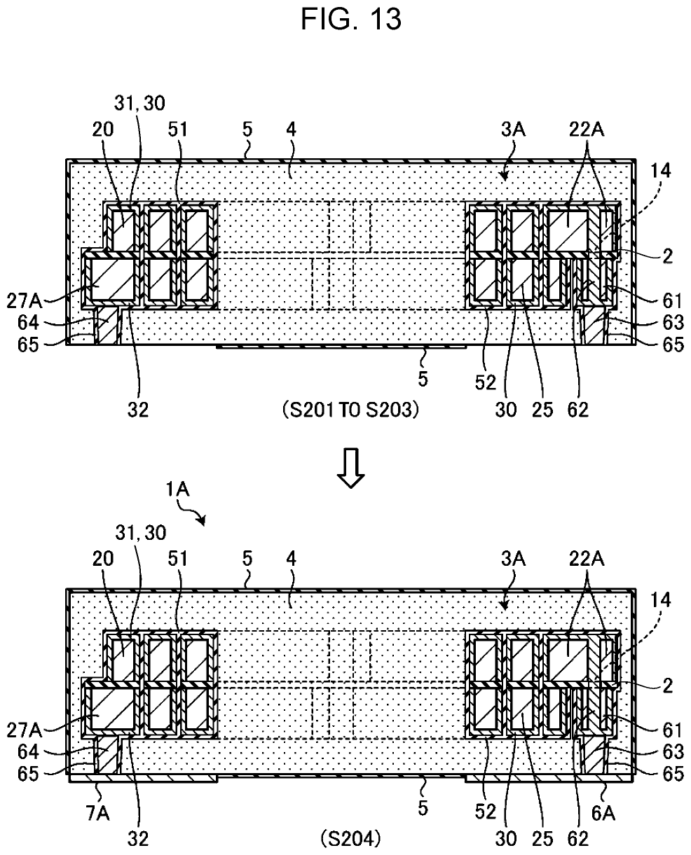

Next, a method for manufacturing the electronic component 1A according to the second embodiment will be described. FIG. 12 is a flow diagram showing an example method for producing the coil part according to the second embodiment. FIG. 12 shows, in the method for producing the coil part 3A, steps from the formation of the coil patterns of the first wiring layer 20 and the second wiring layer 25 to the formation of the first internal terminal 63 and the second internal terminal 64. FIG. 13 is a flow diagram showing an example method for manufacturing an electronic component including the coil part according to the second embodiment. In the second embodiment, first, steps S101 to S108 shown in FIGS. 7 and 12 are sequentially performed to produce the coil part 3A (see FIGS. 10 and 11). Subsequently, steps S201 to S204 shown in FIG. 13 are sequentially performed to manufacture the electronic component 1A including the coil part 3A.

More specifically, first, the base layer forming step S101 is performed as in the first embodiment to produce the coil part 3A. Subsequently, in the pattern forming step S102, a coil pattern is formed on each of the first base layer 41 on the first substrate face 11 and the second base layer 42 on the second substrate face 12 of the substrate 2. At this time, the first coil pattern on the first substrate face 11 is formed such that the patterns for forming the cavity 15 and the first connection end 22A shown in FIG. 12 are included in the first resist 101 (see FIG. 7) on the first substrate face 11. The second coil pattern on the second substrate face 12 is formed such that the patterns for forming the second connection end 27A and the lead-out wiring part 61 shown in FIG. 12 are included in the second resist 102 (see FIG. 7) on the second substrate face 12.

The first coil pattern is the same as that in the first embodiment except that the first coil pattern includes the patterns of the cavity 15 and the first connection end 22A. The second coil pattern is the same as that in the first embodiment except that the second coil pattern includes the patterns of the second connection end 27A and the lead-out wiring part 61. The method for forming the first coil pattern and the second coil pattern is the same as that in the first embodiment.

After the pattern forming step S102, the first plating step S103 and the removal step S104 are sequentially performed. Through these steps, as shown in FIG. 12, the first wiring layer 20 having the first connection end 22A is formed on the first base layer 41 on the first substrate face 11, and the second wiring layer 25 having the second connection end 27A, and the lead-out wiring part 61 spaced apart from the second wiring layer 25 are formed on the second base layer 42 on the second substrate face 12. As shown in FIG. 12, the first connection end 22A is provided with the cavity 15. Furthermore, as shown in FIG. 12, the lead-out wiring part 61 is provided with the cavity 61a that overlaps the cavity 15 in the first connection end 22A in the substrate thickness direction (the vertical direction in the plane of drawing of FIG. 12). The configuration of the first wiring layer 20 is the same as that in the first embodiment except that the first connection end 22A having the cavity 15 is provided. The configuration of the second wiring layer 25 is the same as that in the first embodiment except that the second connection end 27A is provided.

In the second embodiment, the plating treatment performed in the first plating step S103 is the same as that in the first embodiment. The removal step S104 is the same as that in the first embodiment.

After the first plating step S103 and the removal step S104 are sequentially performed, the via hole forming step S105 is performed. As a result, the same via hole 13 as that in the first embodiment is formed in the substrate 2, and the electrode via hole 14 is formed in the substrate 2 as shown in FIG. 12. At this time, as shown in FIG. 12, the electrode via hole 14 is formed inside the cavity 15 in the first connection end 22A and inside the cavity 61a in the lead-out wiring part 61 so as to extend through the substrate 2. As shown in FIG. 12, the thus-formed electrode via hole 14 preferably has the same inner diameter as the cavity 15 and the cavity 61a to form a continuous through hole with the cavity 15 and the cavity 61a. The electrode via hole 14 may be formed in the substrate 2 by laser processing, like the via hole 13, or etching.

After the via hole forming step S105, as shown in FIG. 12, the second plating step S106 is performed. Through these steps, the conducting part 30 is formed in the same manner as in the first embodiment, and the electrode conducting part 62 is formed in the first connection end 22A and the lead-out wiring part 61. At this time, while the surfaces of the first connection end 22A and the lead-out wiring part 61 are plated to form the conductor layer, the electrode via hole 14 is filled with the via conductor part grown from the conductor layer. In this way, the electrode conducting part 62 electrically connecting the first connection end 22A of the first wiring layer 20 and the lead-out wiring part 61 is formed.

The plating treatment for forming the electrode conducting part 62 is the same as that for forming the conducting part 30 in the first embodiment. In the conducting part 30 of the second embodiment, as shown in FIG. 12, the first coating layer 31 is formed so as to cover the surfaces of the regions of the first wiring layer 20 other than the first connection end 22A and so as to be integrated with the electrode conducting part 62 on the surface of the first connection end 22A. As shown in FIG. 12, the second coating layer 32 is formed so as to cover the surfaces of the second wiring layer 25 including the second connection end 27A and so as to be separated from the electrode conducting part 62 on the surface of the lead-out wiring part 61.

After the second plating step S106, as shown in FIG. 12, an internal terminal forming step S106a is performed. As a result, the first internal terminal 63 electrically connected to the first connection end 22A of the first wiring layer 20 through the electrode conducting part 62, and the second internal terminal 64 electrically connected to the second connection end 27A of the second wiring layer 25 through the conducting part 30 are formed.

In the internal terminal forming step S106a, metal plating is performed using the electrode conducting part 62 on the lead-out wiring part 61 as the base layer. As a result, the first internal terminal 63 is formed so as to extend from the base layer (electrode conducting part 62) in the substrate thickness direction (downward in the plane of drawing of FIG. 12). In parallel with this, metal plating is performed using the conducting part 30 (second coating layer 32) on the second wiring layer 25 as the base layer. As a result, the second internal terminal 64 is formed so as to extend from the base layer (second coating layer 32) in the substrate thickness direction (the same direction as the direction in which the first internal terminal 63 extends). The plating treatment for forming the first internal terminal 63 and the second internal terminal 64 is the same as that for forming the electrode conducting part 62.

After the internal terminal forming step S106a, the substrate removal step (see step S107 in FIG. 7) similar to that in the first embodiment is performed. By doing so, of the substrate 2, the regions necessary for the presence of the first wiring layer 20 and the second wiring layer 25 are kept, and the other regions are removed. Subsequently, the same covering step as in the first embodiment (see step S108 in FIG. 7) is performed. As a result, the first insulating layer 51 covering the surfaces of the conducting part 30 on the first substrate face 11 side and the second insulating layer 52 covering the surface of the conducting part 30 on the second substrate face 12 side are formed. In parallel with this, the insulating layer 65 (see FIG. 10) covering the surfaces of the electrode conducting part 62, the first internal terminal 63, and the second internal terminal 64, which are shown in FIG. 12, is formed. The method for forming the insulating layer 65 is the same as the method for forming the first insulating layer 51 and the second insulating layer 52 described above.

Through the process described above, the coil part 3A (see FIGS. 10 and 11) of the second embodiment is produced. Subsequently, as shown in FIG. 13, the sealing step S201, the exterior coating step S202, and the dicing step S203 are sequentially performed. In the second embodiment, the sealing step S201 is the same as that in the first embodiment except that the coil part to be sealed inside the magnetic material is the coil part 3A of the second embodiment, instead of the coil part 3 in the first embodiment.

In the second embodiment, in the exterior coating step S202, the exterior coating 5 is provided on, of the outer surfaces of the molded body of the magnetic material enclosing the coil part 3A, the upper surface, a pair of side surfaces facing each other in the X direction (the horizontal direction in FIG. 13), a pair of side surfaces facing each other in the Y direction (the direction orthogonal to the plane of drawing of FIG. 13), and a part of the lower surface. The method for forming the exterior coating 5 is the same as that in the first embodiment.

In the second embodiment, in the dicing step S203, the molded body of the magnetic material is diced into the bodies 4 each enclosing the coil part 3A, as shown in FIG. 13. At this time, as shown in FIG. 13, each body 4 encloses the coil part 3A in a state in which extending ends of the first internal terminal 63 and the second internal terminal 64 are exposed from the lower surface of the body 4. The exterior coating 5, formed in the exterior coating step S202, is provided on the upper surface, a pair of side surfaces facing each other in the X direction, a pair of side surfaces facing each other in the Y direction, and a part of the lower surface of the body 4. The method for dicing the molded body of the magnetic material is the same as that in the first embodiment.

After the dicing step S203, as shown in FIG. 13, the electrode forming step S204 is performed. Thus, a pair of external electrodes electrically connected to the coil part 3A are provided on the outer surfaces of the body 4.

In the second embodiment, in the electrode forming step S204, as shown in FIG. 13, the first external electrode 6A and the second external electrode 7A are formed on the outer surface of the body 4, at the exposed lower surface regions where the exterior coating 5 is not formed.

The first external electrode 6A is provided on the lower surface of the body 4, at the first lower surface region having a predetermined width and extending from one side surface in the X direction. As shown in FIG. 13, the extending end of the first internal terminal 63 of the coil part 3A is exposed from the first lower surface region. The first external electrode 6A is electrically connected to the first connection end 22A of the first wiring layer 20 via the first internal terminal 63 exposed from the first lower surface region. The second external electrode 7A is provided on the lower surface of the body 4, at the second lower surface region having a predetermined width and extending from the other side surface in the X direction. As shown in FIG. 13, the extending end of the second internal terminal 64 of the coil part 3A is exposed from the second lower surface region. The second external electrode 7A is electrically connected to the second connection end 27A of the second wiring layer 25 via the second internal terminal 64 exposed from the second lower surface region.

As shown in FIG. 13, the exterior coating 5 is disposed between the first external electrode 6A and the second external electrode 7A. This ensures insulation between the first external electrode 6A and the second external electrode 7A. Through the above-described process, the electronic component 1A according to the second embodiment is manufactured.

As described above, the electronic component 1A according to the second embodiment includes the lead-out wiring part 61 extending from the second substrate face 12 in the substrate thickness direction, at a position away from the second wiring layer 25, and the electrode conducting part 62 covering the surfaces of the first connection end 22A of the first wiring layer 20 and the lead-out wiring part 61 and electrically connecting the first connection end 22A and the lead-out wiring part 61 through the electrode via hole 14 extending through the substrate 2. The electronic component 1A also includes the first internal terminal 63 electrically connecting the first wiring layer 20 and the first external electrode 6A through the electrode conducting part 62, and the second internal terminal 64 electrically connecting the second wiring layer 25 and the second external electrode 7A through the conducting part 30 covering the surfaces of the second connection end 27A of the second wiring layer 25. Other than these, the structure of the electronic component is the same as that in the first embodiment.

Accordingly, the same advantageous effects as those obtained by the electronic component according to the first embodiment are obtained. In addition, the first external electrode 6A and the second external electrode 7A provided at a distance from each other on the lower surface of the body 4 can be electrically connected to the first connection end 22A and the second connection end 27A, respectively, of the coil part 3A enclosed in the body 4. Hence, the first external electrode 6A and the second external electrode 7A can serve both as a pair of external electrodes electrically connected to the first connection end 22A and the second connection end 27A of the coil part 3A and a pair of external electrodes used to mount the electronic component 1A on a circuit board. This eliminates the need to provide the pair of external electrodes on the side surfaces of the body 4. This reduces the size of a solder fillet formed when the electronic component 1A is mounted on a circuit board as compared with the case where a pair of external electrodes are present on the side surfaces of the body 4. Accordingly, the mounting area of the electronic component 1A can be reduced.

### Modification

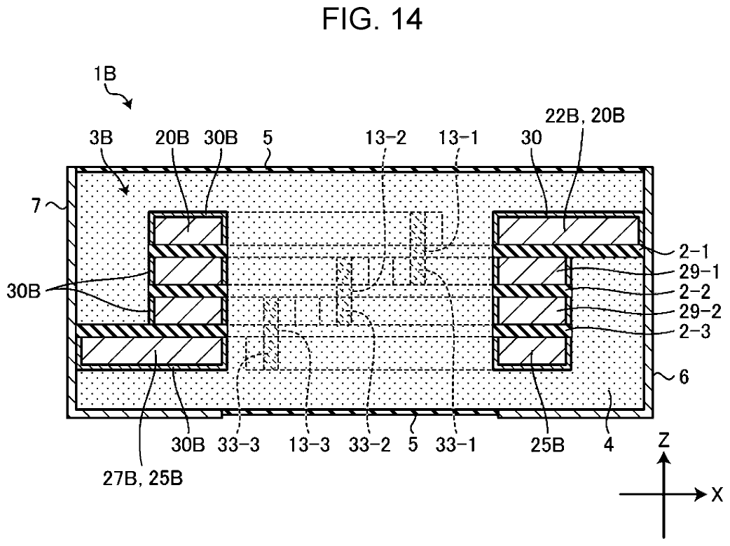

Next, a modification of the electronic component according to the first embodiment will be described. FIG. 14 is a schematic sectional view showing a configuration example of an electronic component according to the modification of the first embodiment. As shown in FIG. 14, an electronic component 1B according to the modification includes a plurality of substrates (for example, three substrates 2-1 to 2-3), instead of the substrate 2 of the electronic component 1 according to the first embodiment. The electronic component 1B also includes a laminated coil part 3B, instead of the spiral coil part 3. The other configurations are the same as those in the first embodiment, and the same reference numerals denote the same components.

The substrates 2-1 to 2-3 are an example of a plurality of substrates at which the laminated coil part 3B is formed. As shown in, for example, FIG. 14, the substrates 2-1 to 2-3 are stacked in the Z direction (the thickness direction of the substrates 2-1 to 2-3) with wiring layers of the coil part 3B interposed therebetween. At this time, the substrate 2-1 is located between a first wiring layer 20B and an intermediate wiring layer 29-1, the substrate 2-2 is located between the intermediate wiring layer 29-1 and an intermediate wiring layer 29-2, and the substrate 2-3 is located between the intermediate wiring layer 29-2 and a second wiring layer 25B. That is, of the two end faces of the substrate 2-1 in the thickness direction, the first substrate face is the substrate face on which the first wiring layer 20B is present, and the second substrate face is the substrate face on which the intermediate wiring layer 29-1 is present. Of the two end faces of the substrate 2-2 in the thickness direction, the first substrate face is the substrate face on which the intermediate wiring layer 29-1 is present, and the second substrate face is the substrate face on which the intermediate wiring layer 29-2 is present. Of the two end faces of the substrate 2-3 in the thickness direction, the first substrate face is the substrate face on which the intermediate wiring layer 29-2 is present, and the second substrate face is the substrate face on which the second wiring layer 25B is present.

As shown in FIG. 14, the substrate 2-1 has a via hole 13-1 for electrically connecting the first wiring layer 20B and the intermediate wiring layer 29-1. The substrate 2-2 has a via hole 13-2 for electrically connecting the intermediate wiring layer 29-1 and the intermediate wiring layer 29-2. The substrate 2-3 has a via hole 13-3 for electrically connecting the intermediate wiring layer 29-2 and the second wiring layer 25B. For example, as shown in FIG. 14, the via holes 13-1 to 13-3 are formed so as not to overlap each other in plan view as viewed in the thickness direction of the substrates 2-1 to 2-3.

The substrates 2-1 to 2-3 are made of the same material as the substrate 2 in the first embodiment. The via holes 13-1 to 13-3 have the same structure as the via hole 13 in the first embodiment. The number of substrates to be stacked and at which the coil part 3B is formed is not limited to the number of substrates 2-1 to 2-3 shown in FIG. 14 (three layers), and may be two or more.

The coil part 3B is a conductor unit having an annular shape in plan view as viewed in the thickness direction of the substrates 2-1 to 2-3, and is disposed inside the body 4, as shown in FIG. 14. More specifically, as shown in FIG. 14, the coil part 3B is a laminated coil part including a plurality of wiring layers stacked with a plurality of substrates interposed therebetween in the thickness direction of the substrates. For example, the coil part 3B includes, as the plurality of wiring layers, the first wiring layer 20B having a first connection end 22B, a second wiring layer 25B having a second connection end 27B, and intermediate wiring layers 29-1 and 29-2 disposed between the first wiring layer 20B and the second wiring layer 25B.

The first wiring layer 20B is a conductor layer having a coil pattern and formed on the first substrate face of the substrate 2-1. For example, the coil pattern of the first wiring layer 20B has an annular shape having 0.5 to 1 turn around the center axis (not shown) parallel to the Z direction of the electronic component 1B in plan view as viewed in the thickness direction of the substrate 2-1 (the vertical direction in the plane of drawing of FIG. 14). Of the two ends of the first wiring layer 20B in the wiring direction, one end is the first connection end 22B to be electrically connected to the first external electrode 6, and the other end is a via pad portion corresponding to the via hole 13-1. The via pad portion has the same structure as the first via pad portion 21 in the first embodiment. The relationship between the via pad portion and the via hole 13-1 is the same as the relationship between the first via pad portion 21 and the via hole 13 in the first embodiment.

The intermediate wiring layer 29-1 is a conductor layer located between the second substrate face of the substrate 2-1 and the first substrate face of the substrate 2-2. For example, the coil pattern of the intermediate wiring layer 29-1 has an annular shape overlapping the first wiring layer 20B described above, in plan view as viewed in the thickness direction of the substrate 2-1. As shown in FIG. 14, one end of the intermediate wiring layer 29-1 in the wiring direction is a via pad portion overlapping the via hole 13-1 in plan view as viewed in the thickness direction of the substrate 2-1. The via pad portion has the same structure as the second via pad portion 26 in the first embodiment. The relationship between the via pad portion and the via hole 13-1 is the same as the relationship between the second via pad portion 26 and the via hole 13 in the first embodiment. As shown in FIG. 14, the other end of the intermediate wiring layer 29-1 in the wiring direction is a via pad portion overlapping the via hole 13-2 in plan view as viewed in the thickness direction of the substrate 2-2. The via pad portion has the same structure as the first via pad portion 21 in the first embodiment. The relationship between the via pad portion and the via hole 13-2 is the same as the relationship between the first via pad portion 21 and the via hole 13 in the first embodiment.

The intermediate wiring layer 29-2 is a conductor layer located between the second substrate face of the substrate 2-2 and the first substrate face of the substrate 2-3. For example, the coil pattern of the intermediate wiring layer 29-2 has an annular shape overlapping the intermediate wiring layer 29-1, in plan view as viewed in the thickness direction of the substrate 2-2. As shown in FIG. 14, one end of the intermediate wiring layer 29-2 in the wiring direction is a via pad portion overlapping the via hole 13-2 in plan view as viewed in the thickness direction of the substrate 2-2. The via pad portion has the same structure as the second via pad portion 26 in the first embodiment. The relationship between the via pad portion and the via hole 13-2 is the same as the relationship between the second via pad portion 26 and the via hole 13 in the first embodiment. As shown in FIG. 14, the other end of the intermediate wiring layer 29-2 in the wiring direction is a via pad portion overlapping the via hole 13-3 in plan view as viewed in the thickness direction of the substrate 2-3. The via pad portion has the same structure as the first via pad portion 21 in the first embodiment. The relationship between the via pad portion and the via hole 13-2 is the same as the relationship between the first via pad portion 21 and the via hole 13 in the first embodiment.

The second wiring layer 25B is a conductor layer having a coil pattern and formed on the second substrate face of the substrate 2-3. For example, the coil pattern of the second wiring layer 25B has an annular shape having 0.5 to 1 turn around the center axis parallel to the Z direction of the electronic component 1B in plan view as viewed in the thickness direction of the substrate 2-3. Of the two ends of the second wiring layer 25B in the wiring direction, one end is a via pad portion corresponding to the via hole 13-3, and the other end is the second connection end 27B to be electrically connected to the second external electrode 7. The via pad portion has the same structure as the second via pad portion 26 in the first embodiment. The relationship between the via pad portion and the via hole 13-3 is the same as the relationship between the second via pad portion 26 and the via hole 13 in the first embodiment.

Although not shown, there are base layers having coil patterns between the substrate faces of the substrates 2-1 to 2-3 and the wiring layers (the first wiring layer 20B, the intermediate wiring layers 29-1 and 29-2, and the second wiring layer 25B) of the coil part 3B. The wiring layers of the coil part 3B are formed by performing metal plating on the base layers. The wiring layers of the coil part 3B are made of the same conductor as the first wiring layer 20 and the second wiring layer 25 in the first embodiment.

The number of turns (the number of windings) and the wiring width in the wiring layers included in the coil part 3B are set in accordance with the characteristics, such as electric resistance and inductance, required for the electronic component 1B. The number of wiring layers stacked in the coil part 3B is not limited to four as shown in FIG. 14, and may be two or more. From the standpoint of reducing the stress applied to the substrates, the number of wiring layers stacked in the coil part 3B is preferably an even number divisible by two, which is a unit of wiring layers formed on the two end faces of a substrate in the thickness direction.

As shown in FIG. 14, the coil part 3B includes the conducting part 30B for electrically connecting the wiring layers of the coil part 3B. The conducting part 30B covers the surfaces of the first wiring layer 20B and the intermediate wiring layer 29-1 and electrically connects the first wiring layer 20B and the intermediate wiring layer 29-1 to each other through the via hole 13-1 in the substrate 2-1. The conducting part 30B also covers the surfaces of the intermediate wiring layers 29-1 and 29-2 and electrically connects the intermediate wiring layers 29-1 and 29-2 to each other through the via hole 13-2 in the substrate 2-2. The conducting part 30B also covers the surfaces of the intermediate wiring layer 29-2 and the second wiring layer 25B and electrically connects the intermediate wiring layer 29-2 and the second wiring layer 25B to each other through the via hole 13-3 in the substrate 2-3.

As shown in FIG. 14, the conducting part 30B includes a via conductor part 33-1 in the via hole 13-1, a via conductor part 33-2 in the via hole 13-2, and a via conductor part 33-3 in the via hole 13-3. The via conductor parts 33-1 to 33-3 are the same as the via conductor part 33 in the first embodiment. The electrical connection structure between the wiring layers by the conducting part 30B is the same as that of the conducting part 30 in the first embodiment. The conducting part 30B is made of the same conductor as the conducting part 30 in the first embodiment. Although not shown, an insulating layer similar to the first insulating layer 51 and the second insulating layer 52 of first embodiment is formed on the surfaces of the conducting part 30B and the substrates 2-1 to 2-3.

As described above, in the modification, the laminated coil part 3B is enclosed in the body 4 of the electronic component 1B. The wiring layers of the coil part 3B are electrically connected to each other by the conducting part 30B, through the via holes 13-1 to 13-3 in the substrates 2-1 to 2-3. Other than these, the structure of the electronic component is the same as that in the first embodiment. Hence, the electronic component 1B having the laminated coil part 3B provides the same advantageous effects as those provided by the electronic component according to the first embodiment.

In the first and second embodiments, the main body of the electronic component encloses a coil part having a two-layer structure, in which spiral wiring layers are formed on two end faces of a substrate in the thickness direction. However, the present invention is not limited thereto. For example, the coil part of the electronic component according to the present invention may have a single-layer structure, in which a spiral wiring layer is formed on one end face of a substrate in the thickness direction, or a multilayer structure, in which spiral wiring layers formed on two end faces of a substrate in the thickness direction are stacked in the thickness direction. From the standpoint of reducing the stress applied to the substrates, the number of wiring layers included in the coil part is preferably an even number divisible by two, which is a unit of wiring layers formed on the two end faces of a substrate in the thickness direction.

In the second embodiment, the coil part 3A is sealed in the molded body (the body 4) of the magnetic material 115 after the first internal terminal 63 and the second internal terminal 64 are formed in the internal terminal forming step S106a. However, the present invention is not limited thereto. For example, the coil part 3A is sealed in the molded body of the magnetic material 115, a first hole extending to the electrode conducting part 62 and a second hole extending to the conducting part 30 (second coating layer 32) on the surface of the second connection end 27A are formed in the lower surface of the molded body by using a device such as a drill, and the inner sides of the first hole and the second hole are plated to form the first internal terminal 63 and the second internal terminal 64. It is also possible not to provide the first internal terminal 63 and the second internal terminal 64 in the coil part 3A. The electrode conducting part 62 electrically connected to the first connection end part 22A and the second coating layer 32 formed on the surfaces of the second connection end 27A are exposed from the lower surface of the body 4. The exposed portion of the electrode conducting part 62 may be electrically connected to the first external electrode 6A, and the exposed portion of the second coating layer 32 may be electrically connected to the second external electrode 7A.

In the first and second embodiments, the coil part enclosed in the body of the electronic component has a spiral coil pattern as shown in FIGS. 4 and 5. However, the present invention is not limited thereto. For example, the coil pattern of the coil part of the present invention may be a circular pattern, an oval pattern such as an elliptical pattern or a rounded rectangular pattern, or a rectangular pattern in plan view as viewed in the thickness direction of the substrate.

The present invention is not limited by the first and second embodiments and the modification. The present invention includes configurations obtained by appropriately combining the above-described components. In addition, other embodiments, examples, operation techniques, and the like made by those skilled in the art according to the first or second embodiment or the modification are all included in the scope of the present invention.

1. An electronic component comprising:
a substrate having a first substrate face and a second substrate face opposite to the first substrate face in a thickness direction of the substrate; and
a coil part having an annular shape in plan view from the thickness direction, wherein the coil part includes:
a first wiring layer having a first coil pattern and formed on the first substrate face;
a second wiring layer having a second coil pattern and formed on the second substrate face; and
a wiring conducting part having coatings covering surfaces of the first wiring layer and the second wiring layer, the wiring conducting part electrically connecting the first wiring layer and the second wiring layer through a wiring via hole extending through the substrate.

2. The electronic component according to claim 1, wherein the coil part includes:
a first via pad portion formed as an end of the first wiring layer in a wiring direction thereof and having a maximum width smaller than or equal to a wiring width of the first wiring layer, the first via pad portion wiring surrounding a first opening of the wiring via hole on the first substrate face side; and
a second via pad portion formed as an end of the second wiring layer in a wiring direction thereof and having a maximum width smaller than or equal to a wiring width of the second wiring layer, the second via pad portion surrounding a second opening of the wiring via hole on the second substrate face.

3. The electronic component according to claim 1,
wherein each of the first coil pattern and the second coil pattern forms a spiral in the plan view,
and wherein the wiring conducting part includes a portion is in contact with an end of the spiral of the first wiring layer and an end of the spiral of the second wiring layer through the wiring via hole.

4. The electronic component according to claim 1, further comprising an insulating layer covering surfaces of the wiring conducting part.

5. The electronic component according to claim 1, further comprising:
a main body containing a magnetic powder, the coil part being embedded in the main body; and
a pair of first external electrode and second external electrode provided on an outer surface of the main body, the first external electrode being and electrically connected to the first wiring layer, and the second external electrode being electrically connected to the second wiring layer.

6. The electronic component according to claim 5,
wherein the first wiring layer includes a connection end exposed on the outer surface of the main body and connected to the first external electrode, and the second wiring layer includes a connection end exposed on the outer surface of the main body and connected to the second external electrode.

7. The electronic component according to claim 5, wherein the coil part further includes:
a lead-out wiring extending from the second substrate face in the thickness direction at a position away from the second wiring layer;
an electrode conducting part electrically connecting the lead-out wiring and a connection end of the first wiring layer through an electrode via hole formed through the substrate, the electrode conducting part including a portion that covers a surface of the lead-out wiring and a surface of the connection end of the first wiring layer, the connection end overlapping the lead-out wiring in the plan view from the thickness direction;
a first internal terminal electrically connecting the first external electrode to the electrode conducting part, whereby the first external electrode is electrically connected to the first wiring layer; and
a second internal terminal electrically connecting the second external electrode to the wiring conducting part that covers a surface of a connection end of the second wiring layer, whereby the second external electrode is electrically connected to the second wiring layer.

8. The electronic component according to claim 1, further comprising:
a first base layer formed on the first substrate face between the first wiring layer and the first substrate face; and
a second base layer formed on the second substrate face between the second wring layer and the second substrate face.

9. The electronic component according to claim 8,
wherein the first base layer has a same coil pattern as the first wiring layer, and the second base layer has a same coil pattern as the second wiring layer.

10. The electronic component according to claim 8,
wherein the first base layer and the second base layer are conductor layers containing at least one of nickel, chromium, and or titanium,
and wherein the first wiring layer, the second wiring layer, and the wiring conducting part are conductor layers containing copper.

11. The electronic component according to claim 1, wherein the wiring conducting part includes:
a first coating layer covering the surface of the first wiring layer;
a second coating layer covering the surface of the second wiring layer; and
a via conductor part filling the wiring via hole.

12. A method for manufacturing an electronic component, the method comprising:
providing a substrate having a first substrate face and a second substrate face opposite to the first substrate face in a thickness direction of the substrate;
forming a first base layer on the first substrate face and a second base layer on the second substrate face;
forming a first resist pattern exposing a first coil pattern on the first base layer, the first resist pattern including a first via pattern covering a portion for an opening on the first substrate face, and forming a second resist pattern exposing a second coil pattern on the second base layer, the second resist pattern including a second via pattern covering a corresponding portion for an opening on the second substrate face corresponding to the opening on the first substrate face;
plating a surface of the first base layer through the first resist pattern, thereby forming a first wiring layer having a first via cavity that extends to the first substrate face, and plating a surface of the second base layer through the second resist pattern, thereby forming a second wiring layer having a second via that extends to the second substrate face at a position corresponding to the first via;
forming a wiring via hole extending through the substrate from the first substrate face inside the first via to the second substrate face inside the second via; and
plating surfaces of the first wiring layer and the second wiring layer to form a conductor layer thereon and forming a via conductor part grown from the conductor layer to fill the wiring via hole, thereby electrically connecting the first wiring layer and the second wiring layer.

13. The method for manufacturing the electronic component according to claim 12, wherein the forming the wiring via hole includes a laser processing or etching.
